(19) United States
(12) Patent Application Publication
(10) Pub. No.: US 2010/0002685 A1
(43) Pub. Date: Jan. 7, 2010

(54) METHOD AND SYSTEM FOR PROVIDING COMMUNICATION

(76) Inventors: Eliezer SHAHAM, Givat-Ada (IL); Gadi Guy, Elishama (IL); Amir Arad, Tel Aviv (IL); Zohar Brin, Ramat Hasharon (IL)

Correspondence Address: Pearl Cohen Zedek Latzer, LLP, 1500 Broadway, 12th Floor, New York, NY, 10036, US

(21) Appl. No.: 12/494,382

(22) Filed: Jun. 30, 2009

Related U.S. Application Data
(60) Provisional application No. 61/076,718, filed on Jun. 30, 2008.
(60) Provisional application No. 61/140,641, filed on Dec. 24, 2008.

(51) Int. Cl. H04L 12/66; G06F 3/00

(52) U.S. Cl. 370/352; 715/733

(57) ABSTRACT

A communication system, the system including: (i) a first network interface for communicating with a remote system over a network, wherein the first network interface is configured to: (a) receive a conversation initiation request generated in response to an interaction with a conversation trigger that is included in a web page that is displayed at a remote system; wherein the conversation initiation request includes context metadata that pertains to content of the web-page; and (b) provide to the remote system a communication widget that is configured in response to the context metadata; and (ii) a management unit, configured to initiate a communication session between the communication widget and a recipient, for transmitting conversation signals between the remote system and the recipient.

### CROSS-REFERENCE TO RELATED APPLICATIONS

This application claims the priority of U.S. provisional patent Ser. No. 61/076,718, filing date Jun. 30, 2008, entitled “A method, a system and a computer program product for contextual Communications”; and of U.S. provisional patent Ser. No. 61/140,641, filing date Dec. 24, 2008, entitled “Specification of Available In-Place Call Technology”.

### FIELD OF THE INVENTION

The invention relates to methods and systems for providing communication, and especially to voice over IP (VoIP) systems and method.

### BACKGROUND OF THE INVENTION

Prior art communication solutions enable a user of a system to use voice over IP solution that requires downloading of dedicated application. There is a real need for reliable and simple means of communicating from within a web-page that is viewed by the user, e.g. a page that includes information that is useful for the user, where the voice communication is intended for acquiring additional information pertaining to information presented in the web-page.

### SUMMARY OF THE INVENTION

A communication system, the system including: (i) a first network interface for communicating with a remote system over a network, wherein the first network interface is configured to: (a) receive a conversation initiation request generated in response to an interaction with a conversation trigger that is included in a web page that is displayed at a remote system; wherein the conversation initiation request includes context metadata that pertains to content of the web-page; and (b) provide to the remote system a communication widget that is configured in response to the context metadata; and (ii) a management unit, configured to initiate a communication session between the communication widget and a recipient, for transmitting conversation signals between the remote system and the recipient.

A method for providing communication, the method including carrying out the following steps by a communication system: (i) receiving a conversation initiation request generated in response to an interaction with a conversation trigger that is included in a web page that is displayed at a remote system; wherein the conversation initiation request includes context metadata that pertains to content of the web-page; (ii) providing to the remote system a communication widget that is configured in response to the context metadata; and (iii) initiating a voice communication session between the communication widget and a recipient, for transmitting conversation signals between the remote system and the recipient.

A computer readable medium, having a computer readable code embodied therein for providing communication, the computer readable code including instructions for: (i) receiving a conversation initiation request generated in response to an interaction with a conversation trigger that is included in a web page that is displayed at a remote system;, wherein the conversation initiation request includes context metadata that pertains to content of the web-page; (ii) providing to the remote system a communication widget that is configured in response to the context metadata; and (iii) initiating a voice communication session between the communication widget and a recipient, for transmitting conversation signals between the remote system and the recipient.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 illustrates a system, according to an embodiment of the invention;

FIGS. 2A and 2B are process diagrams for the system of FIG. 1, according to different embodiments of the invention;

FIG. 3 illustrates a system, according to an embodiment of the invention;

FIG. 4 illustrates a selection of a communication server out of a plurality of servers of a communication system, according to an embodiment of the invention;

FIGS. 5 and 6 illustrate displays of a web-page, according to an embodiment of the invention; and

FIGS. 7A through 7C illustrate a method 500 for providing communication, according to an embodiment of the invention.

### DETAILED DESCRIPTION OF THE DRAWINGS

This application claims the priority of U.S. provisional patent Ser. No. 61/076,718, filing date Jun. 30, 2008, entitled “A method, a system and a computer program product for contextual Communications”; and of U.S. provisional patent Ser. No. 61/140,641, filing date Dec. 4, 2008, entitled “Specification of bAvailable In-Place Call Technology”, both of which are incorporated herein by reference.

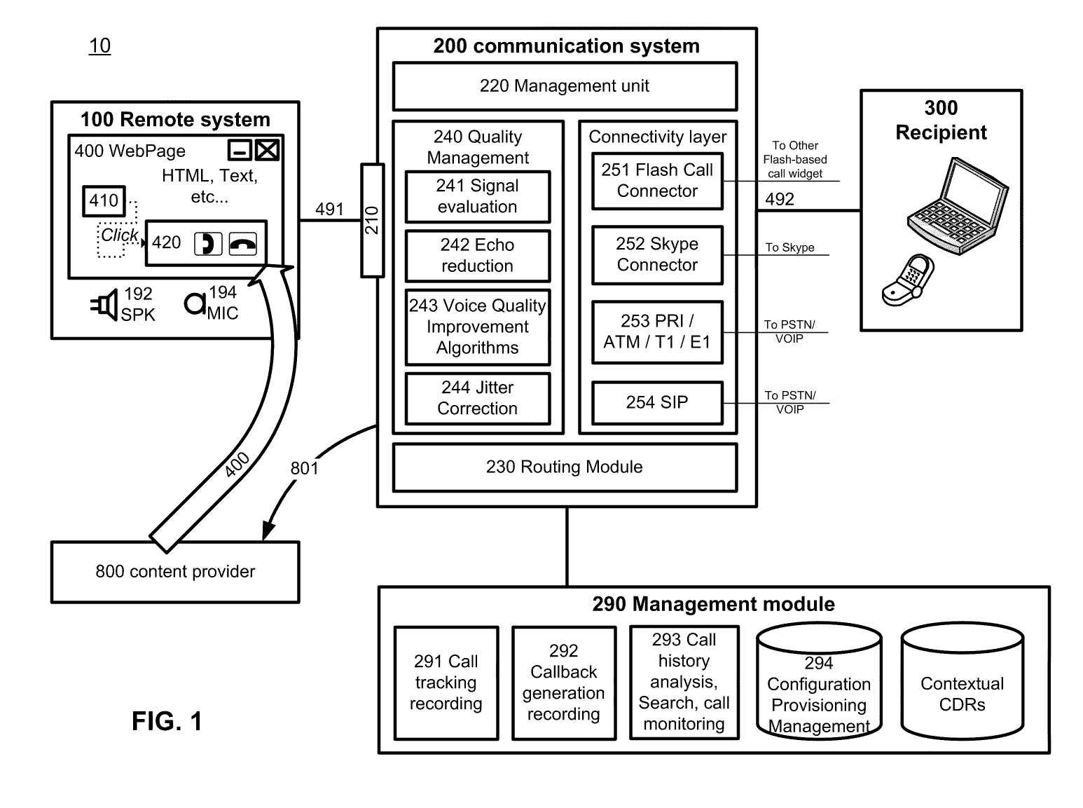

FIG. 1 illustrates system 10, according to an embodiment of the invention. system 10 includes communication system 200 (e.g. a central communication system that includes a structure of one or more communication servers), at least one remote system 100 (e.g. a personal computer, a web browser, a personal digital assistant, as so forth) that is connected to communication system 200 over communication network (denoted 491, e.g. the internet, albeit the system can be implemented for other networks, e.g. WANs), and at least one recipient 300 that is also connected to communication system 200 over a network (denoted 492, but could be either the same network as 491, and could be a local network, e.g. of a service provider).

Referring to communication system 200 (also simply referred to as system 200), system 200 includes first network 210, management unit 220, and additional other component according to different embodiments of the invention, as discussed below.

First network interface 210 is used for communicating with remote system 100 over the network 491. First network interface 210 is configured to receive a conversation initiation request that is generated in response to an interaction with a conversation trigger 410 that is included in web page 400 that is displayed at remote system 210 (usually by a user), wherein the conversation initiation request includes context metadata that pertains to content of web-page 400.

Such context metadata may include—by way of example and not intending to limit the scope of the invention in any way—the name of the web site, identifying information of web page 400, HTML text quotes from web page 400, and other associated information (e.g. depending on a structure of web-page 400, each conversation trigger 410 may be accompanied by other information such as text, images, sound, etc. it is noted that not all of that information is necessarily visible to a user of remote system 100, but usually at least some of the content that is used for the context metadata is also visible to such a user).

It is noted that while the aforementioned interaction with conversation trigger 410 may be of the user of remote system 100 (e.g. by pressing or otherwise activation the conversation trigger 410), other interactions may also be implemented, such as interaction of a recipient 300, as disclosed below. it is noted that several types of interactions with conversation trigger 410 may be implemented a single embodiment of the invention.

It is noted that, according to an embodiment of the invention, first network interface 210 is further configured for receiving the conversation initiation request that further includes context metadata that pertains to a user that views the web-page. This may be implemented for registered user (e.g. of a website that includes web page 400) but also for non-registered users (usually information to current session in the website). For example, the context metadata that pertains to the user may include one or more of the following: a user's login credential, a user's level of authorization or service provisioning, a user's history of URLs visited by user that is stored in the server—including associative context of visited URLs (e.g. user visited sites related to French books based on keywords extracted from the past pages).

The context metadata is used for generating, following the receiving of the conversation initiation request, communication widget 420 and configuring it (or for configuring an existing communication widget 420, according to an embodiment of the invention). The configuring of communication widget 420 according to the context metadata may include configuring different parameters, according to different embodiments of the invention.

Firstly, communication widget 420 may include a unique identifier, that will be used when communicating with communication system 200, and which may be used by system 200 to better handle communication with communication widget 420 (e.g. voice communication). Additionally, communication 420 may include, according to an embodiment of the invention, identification information relating to recipient 300, and different communication parameters for future communication between communication widget 420 and communication system 200 (or other system). According to an embodiment of the invention, first network interface 210 is further configured for receiving the conversation initiation request that further includes context metadata that pertains to a user that views web-page 400. It is noted that additional communication parameters may be also decided upon later, e.g. during such communication.

It is noted that conveniently, a single user may receive substantially different communication widgets 420 (e.g. having different functionalities, or one of them having extended/reduced functionalities, looking different, having different communication priority, etc) when using different conversation triggers 410, even on the same web page 400, depending on the context of the conversation trigger 410. Likewise, triggering a single conversation trigger 410 at different times by the same user may result in receiving two substantially different communication widgets 420 (e.g. depending on a schedule defined by a publisher of the conversation trigger 410). Also, two different users may receive different communication widgets 420 when triggering conversation triggers in the same web page 400 (e.g. one of them being prioritized customer).

Communication widget 420 usually includes user interface objects such as buttons, sliders, etc., a graphical representation, audio capabilities, and code enabling communication widget 420 to communicate with audio equipment of remote system 100 (e.g. microphone 194 and speaker 192) and to communicate with another system over network 491. It is noted that according to an embodiment of the invention, communication widget 420 is a flashed based communication widget.

It is noted that the configuring of communication widget 420 may be carried out by management unit 220, or by another unit.

First network interface 210 is also configured to provide communication widget 420 to remote system 100; wherein as aforementioned, communication widget 420 is configured in response to the context metadata. It is noted that communication widget 420 may be implemented in various ways, according to different embodiments of the invention. For example, according to various embodiments of the invention, first network interface 210 may be configured to provide to remote system 100 an ActiveX based communication widget, and/or a java applet based communication widget.

Conveniently, once remote system 100 receives communication widget 420, it incorporates communication widget 420 into the same web-page 400 that is displayed in remote system 100, so that the communication widget 420 is displayed to a user of remote system 100, and is accessible to whom from web-page 400. It is noted that communication widget 420 may be automatically activated (e.g. when the conversation starts without further request from a user of remote system 100), or may be idle, and waits for activation by the user.

Communication system 200 further includes management unit 220, which is configured to initiate a communication session between communication widget 420 and recipient 300, for transmitting conversation signals between remote system 100 and recipient 300. It is noted that according to different embodiments of the invention, the communication session may be either started automatically or being triggered by one of the parties—communication widget 420, communication system 200, or recipient 300.

According to different embodiments of the invention, the communication session may be a voice communication session, a video communication session, a chat session, and so forth, or any combination thereof. It is noted that, according to an embodiment of the invention, the communication session may include more than two participants, wherein the required changes are applied to the different aspects of communication system 200. Respectively, the conversation signals may include sound signals (e.g. in voice communication), video signals (e.g. in a video conference), text communication signals (e.g. in a chat session), and so forth.

It is noted that communication system 200 may route the communication session itself, but may also, according to an embodiment of the invention, refer the communication session to another system. As will be described below, the identity of recipient 300 is either associated with the conversation trigger 410, or is determined by communication system 200 (or by another system connected thereto).

Referring now to conversation trigger 410. According to an embodiment of the invention, conversation trigger 410 is a portion of HTML/JavaScript code that can be inserted into HTML documents, e.g. by an owner of web-page 400, by an intermediary party, by a software installed on remote system 100, and so forth.

Conveniently, conversation trigger 410 present a graphic representation of the possibility to initiate a voice call or other type of communication—e.g. video—with another party (can be another web user, a website operator, or an advertiser for example). For example—the other web user may be another client interested in the product or service offered in the web site.

Conveniently, conversation trigger 410 is clickable (i.e. users can click conversation triggers 410, whether those are text or image links or any other form of clickable HTML objects).

When clicking conversation trigger 410, conversation trigger 410 provides context metadata, which is either previously stored in conversation trigger 410 previously, and/or is gathered by conversation trigger 410 as a result of the triggering thereof. According to an embodiment of the invention, such information that is stored and passed by conversation trigger 410 contain key that allow communication system 200 to correctly identify, generate and track calls made by conversation trigger 410.

For example, the information that is embedded in conversation trigger 410 may include, according to different embodiments of the invention, some or all of the following:
a. A unique identifier representing recipient 300. The unique identifier may or may not be the phone number or other public identity of recipient 300—or it may be a unique identifier which is private to system 10 and therefore communication system 200 is responsible in such an embodiment for translating such identity into a valid identifier used to call the other party over other networks such as PSTN or Skype for instance.
b. A unique identifier representing the web context that is associated with the specific conversation trigger 410 that embeds such information. The ‘web context’ is a set of data items that can contain the URL of webpage 400, in addition it may contain a pointer to a specific location in webpage 400 (a single webpage 400 can contain several conversation triggers 410 each pointing to different ‘web contexts’) and in addition the web context can contain various meta-data such as: an identity of customer/campaign/involved third parties/times and dates/categorical information or any other relevant data. It is noted that, according to an embodiment of the invention, the context metadata provided by conversation trigger 410 refers communication system 200 to a database entry in a database of communication system 200, in which additional context metadata is stored.

Referring to communication widget 420, as aforementioned communication widget 420 may be a Flash based communication widget, but this is not necessarily so. Adobe Flash is a technology that allows embedding ‘applets’ directly in web-pages (the application appears as part of the webpage that hosts it, and the user interacts with the flash applet as if it is an integrated part of the displayed webpage).

According to an embodiment of the invention, communication widget 420 is a communications software that is programmed as a flash applet and packaged in a single SWF file, e.g. a voice communication software that is programmed as a flash applet and packaged in a single SWF file.

It is noted that according to an embodiment of the invention, communication widget 420 is usable in remote system 100 without a process of installing and/or getting approve for the download of communication widget 420. It is noted that most web browsers facilitate such operation for Flash applets.

It is noted that while communication widget 420 is described as supporting voice communication, according to different embodiments of the invention communication widget 420 may support other types of communication as well, such as text (chat) and video conference.

As for the identity of recipient 300, it may be associated with information included in the context metadata (e.g. a specific message in an electronic bulletin board may be associated with a specific recipient 300), it may be selected by a user of remote system 100 (e.g. by selecting from a list of different departments in a company help line), by communication system 200 (e.g. according to some decision rules) and may even be selected by a recipient 300 or associated entity (e.g. available sales representative).

It is noted that selecting of the user may also be implemented as selecting the recipient's audio enabled address such as E.164 MSISDN, SIP ID, Skype ID etc.

It is noted that, according to an embodiment of the invention, management unit 220 is further configured to select recipient 300 in response to the context metadata. It is noted that management unit 220 (or other entity of system 10 that select recipient 300) may utilize additional parameters for selecting recipient 300. For example, availability schedule may be used, as well as operational status (e.g. a sales representative that is free is more likely to be selected, rather than having a user of communication widget 420 waiting for another representative). Furthermore, it is noted that recipient 300 may be reached in different ways (e.g. by a VoIP software, by a landline, and by a cellular phone), wherein the selecting may further include selecting of communication medium.

According to an aspect of the invention, communication system 200 may provide different parties with information pertaining to the conversation.

According to an embodiment of the invention, communication system 200 is further configured to provide to content provider 800 which is associated with web-page 400 information (denoted 801) relating to the communication session, wherein the content provider 800 is identified in response to the context metadata. It is noted that, according to an embodiment of the invention, content provider 800 is an owner of web page 400. However, content provider 800 may be otherwise connected with web-page 800. It is noted that content provider 800 may be related to recipient 300 (e.g. recipient 300 is a sales representative contacted from a webpage 400 of the company of content owner 800), or non-related (e.g. recipient 300 publishes a post, an advertisement and so forth in web-page 400 of content owner 800).

It is noted that while in many prior art systems a content owner that have a web-page does not receive any information pertaining to communication between visitors to his website and publishers in his web site (this is even so if the communication is a VoIP communication initiated from a button incorporated by a program such as Skype), in the disclosed system content owner 800 may be informed of any communication initiated from a conversation trigger 410 that is located in his web-page 400, and thus receive revenues or otherwise benefit from the communication. It is noted that the information provided to content owner may be related to the communication (e.g. duration), and usually also includes information from the context metadata.

According to an embodiment of the invention, second network interface 492 is further configured for providing to recipient 300 conversation related information that is responsive to the context metadata. For example, recipient 300 may be notified about the web-page 400 from which the communication was triggered, about the user calling, and so forth. For example, the providing of the conversation related information to the recipient may include announcing the web context associated with a call via a text to speech module or playback of a recorded message, immediately after the called party answers a call that originates from a webpage or banner.

It is noted that the actual routing of conversation packets of the conversation communication system may be either carried out by communication system 200 (e.g. by a server out of one or more communication servers of communication system 200), or by another system that is notified by communication system 200.

According to an embodiment of the invention, communication system 200 includes routing module 230 that is configured for routing conversation packets of the conversation communication session. It is noted that routing module 230 may be a part of (or otherwise related to) a contextual call routing layer, but this is not necessarily so.

As aforementioned, communication widget 420 may be a flash based communication widget, in which case the communication between communication system 200 and communication widget 420 is usually Real Time Messaging Protocol (RTMP) communication which is a proprietary protocol developed by Adobe Systems for streaming audio, video and data over the Internet, between a Flash player and a server.

According to an embodiment of the invention, routing module 230 is further configured for routing transport layer conversation packets. It is noted that raw RTMP protocol complies with TCP, which is a transport layer protocol.

According to an embodiment of the invention, routing module 230 is further configured for routing application layer conversation packets. It is noted that the RTMPT and RTMPS protocols transmit communication over HTTP communication, which is an application layer protocol.

It is noted that according to an embodiment of the invention, communication widget 420 may use any of several protocols to which it is configured for the voice communication—or other type of conversation, e.g. as discussed above. It is noted that communication widget 420 usually transmits a second initiation request for beginning the voice communication, or the other conversation type. According to an embodiment of the invention, communication widget 420 is adapted to send several second initiation requests according to different protocols, either together or one after the other, even before any reply have been receive. For example, communication widget 420 may transmit an RTMP initiation request, to transmit 0.5 seconds later an RTMPT initiation request and 0.5 seconds after that to transmit an RTMPS initiation request (in which case the order of the second initiation requests usually matches preferences of protocols for voice communication, or other communication protocols—e.g. of video communication). According to an embodiment of the invention, communication system 200 may receive several second initiation requests from communication widget 420, and to respond only to one of them (usually the one received first, or a preferred one according to another embodiment of the invention).

Referring to the routing of the communication session, it is noted that according to an embodiment of the invention, communication system 200 is capable of routing voice conversations into different scenarios or receiving parties, based on its internal logic and based on the configuration stored in a database (e.g. configuration provisioning database 294 of management module 290 to which communication system 200 is connected) for the identification of receiving 300 and/or web context.

For example, the incoming communication calls can be routed through one or more of the following options/scenarios:
Placed on hold.
Served music and other media files out of a repository of media files.
Served contextually targeted audio advertising out of a repository of available audio ads stored at a database or retrieved from an external content owner.
Caller (user of remote system 100) can be presented an audio IVR menu for selection of different routing choices via DTMF.
Caller can be routed to different phone numbers, e.g. Skype, VoIP trunks or other communication widgets 420 that are configured as means of communicating the intended receiving party.
Caller can be routed and bridged with access numbers that lead to external IVR applications (for instance IVR applications that are part of an advertiser's call center).

Since communication widget 420 is provided to a user of remote system 100 as part of web page 400, the user may accidentally close a browser window or tab that displays web page 400, which may call unintended interruption of the conversation communication session. In order to over come this, according to an embodiment of the invention communication widget 420 is configured to identify such situation, and to open a popped up window (or parallel solution) that includes a communication widget (similar to or different from communication widget 420) for renewing the conversation communication session. Any of those communication widgets may provide communication system 200 with an interference indication relating to the closing of web page 400 (e.g. by user, or by computer code), so that communication system 200 may renew the conversation communication session with remote system 100. It is noted that since the user have conveniently already authorized the communication (by triggering the conversation), pop-up blockers of remote system 100 will usually allow this mechanism to operate.

According to an embodiment of the invention, first network interface 491 is further for receiving interference indication relating to a closing of web page 400 (by user or by code) that is displayed in remote system 100, wherein management unit 220 is further configured to renew the conversation communication session with a communication widget that is included in a popped up window (not illustrated) of remote system 100.

According to an embodiment of the invention, communication system 200 includes a quality management module 240 for handling call quality issues (and potentially quality of service issues as well).

According to an embodiment of the invention, communication system 200 includes signal evaluation unit 241 that is configured to evaluate a sound quality of voice communication with remote system 100 (or alternatively video quality, etc.), and wherein management unit is further configured to select a processing unit (e.g. one of several processors of system 200, one or several communication servers of system 200, and so forth) that will participate in a routing of the conversation communication session in response to a result of the evaluating, wherein different processing unit of communication system 200 have different sound processing capabilities.

According to an embodiment of the invention, communication system 200 further includes one or more of the following components: echo reduction module 242, voice quality improvement algorithms module 243, and jitter correction module 244.

It is noted that according to different embodiments of the invention, the functions of modules 242, 243, and 244, as well as other signal processing functions (many of which are known in the art) may be carried out by one or more signal processing module (not illustrated). According to an embodiment of the invention, communication system 200 includes a signal processing module (such as echo reduction module 242) that is configured to reduce echo from conversation sound signals that are received from remote system 100, before providing the conversation sound signals to recipient 300. It should be noted that, according to an embodiment of the invention, the signal processing module is configured to reduce echo (or to otherwise process) signals that are received from recipient 300. According to an embodiment of the invention, at least one signal processing module is configured to improve a quality of video communication, or other types of conversation communication.

It is noted that in prior art system, the echo reduction is carried out in either one of the ends of the conversation, and not in an intermediary system such as communication system 200. It is noted that flash widgets may have difficulties in reducing echo, and therefore in such situations, for example, it is not practical to reduce echo in one of the ends.

It is noted that a way to reduce echo by an intermediary communication system is disclosed in detail in US patent application entitled “Methods and systems for voice communication” by the same applicants, filed on 30 Jun. 2009, which is incorporated herein by reference.

According to an embodiment of the invention, the signal processing module is configured to: (a) transmit to remote system 100 a first sound sequence (e.g. a signature sound sequence that is 100 ms long, and which contain signals that vary in amplitude and frequency in a way that can be easily distinguishable from carrier signal or common background noise); (b) receive from remote system 100 a returning sound sequence that is responsive to the first sound sequence (thus usually it includes echo effects); and (c) determine an echo reduction parameter in response to a relationship between a first sound sequence parameter and a second sound sequence parameter.

Once the echo reduction parameter have been determined by the signal processing module that is included in communication system 200, communication system 200 may utilize it for reducing echo in voice signals that are received from remote system 100. Alternatively, once the signal processing module that is included in communication system 200 has determine an echo reduction parameter, it may transmit it to communication widget 420 (or to recipient 300) for reducing echo, which in that case is usually a simpler task then determining the value of the echo reduction parameters. It is noted that conveniently, communication system 200 is configured to re-evaluate the echo, and to update the value of the echo reduction parameter accordingly.

According to an embodiment of the invention, communication system 200 is further configured to transmit to recipient 300 a processed sound sequence that was generated in response to the echo reduction parameter from a preprocessed sound sequence which was generated by remote system 100.

According to an embodiment of the invention, the signal processing module is further configured to: (a) determine a delay period between a transmitting time of the first sound sequence and a reception time of the returning sound sequence; (b) transmitting, prior to a transmission of the processed sound sequence, to remote system 100 a second sound sequence, after the determining of the delay period; and (c) process the preprocessed sound sequence in response to the delay period and in response to the second sound sequence, to provide the processed sound sequence.

According to an embodiment of the invention, the signal processing module is configured to determine an echo reduction parameter and to transmit the echo reduction parameter to remote system 100, wherein communication system 200 is further configured to receive from remote system a sound sequence that is generated by remote system 100 in response to the echo reduction parameter.

It is noted that, according to different embodiments of the invention, communication system 200 can enable voice communication with recipients 300 that use different kind of communication technologies, such as (though not limited to) voice over IP programs (VoIP, e.g. Skype), to public switched telephone network (PSTN, e.g. complying with any of the following conventions: PRI/ATM/T1/E1) either by a landline or wirelessly, to another communication widget 420, and so forth.

According to an embodiment of the invention, one or more of those communication solutions are being facilitated by connectivity layer 250 of communication system 200 (e.g. by components 251-254 of which).

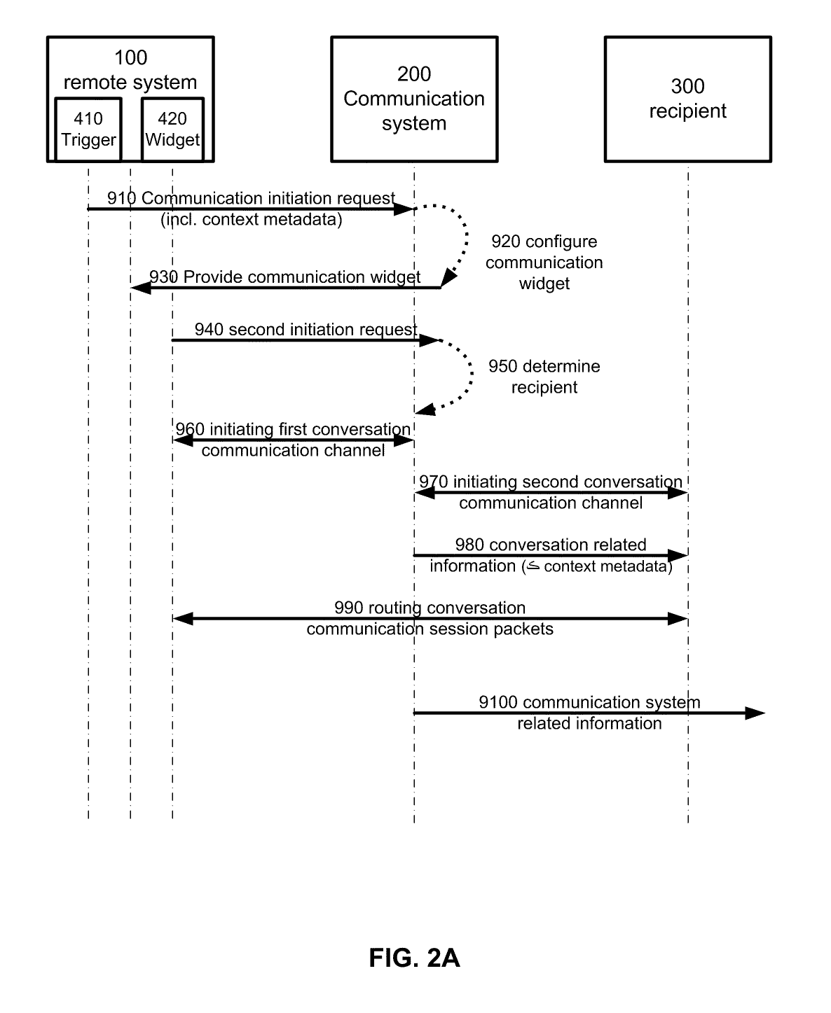

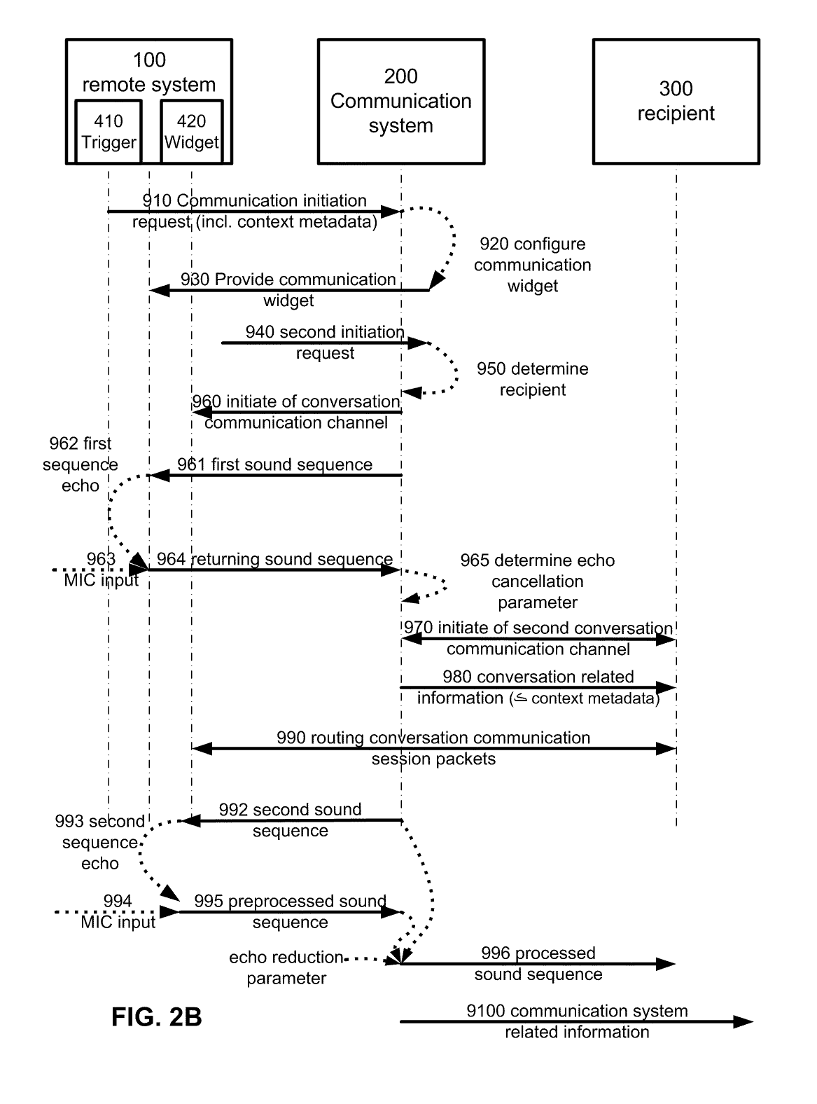

FIGS. 2A and 2B are process diagram for system 10, according to different embodiments of the invention. In step 910 conversation trigger 410 that is included in web page 400 transmits (usually upon being triggered by a user of remote system 100) to communication system the conversation initiation request that includes the context metadata. In step 920 communication system 200 configures (and possibly generates beforehand) communication widget 420, that is being transmitted to remote system 100 in step 930. After being received by remote system 100, communication widget 420 transmits (again, usually upon being triggered by a user of remote system 100) to communication system 200 a second initiation request (step 940), this time requesting an initiation of conversation communication session.

According to an embodiment of the invention, in step 950 communication system 200 may select recipient 300, even though it should be noted that the identity of recipient 300 may be determined by another party, and/or at another time into the process. It is noted that the selecting of the recipient may include, according to various embodiments of the invention, selecting the recipient's audio enabled address such as E.164 MSISDN, SIP ID, Skype ID etc, video conversation enabled address, chat enabled address, PSTN number, and so forth.

In step 960, a first conversation communication channel (e.g. a voice communication channel, a video communication channel, a chat communication channel) is initiated between communication widget 420 and communication system 200. In step 970, a second conversation communication channel is initiated between communication system 200 and recipient 300. It is noted that according to other embodiments of the invention, the first and second conversation communication channels may be generated between communication widget 420 or recipient 300 (respectively) to another intermediary system by communication system 200. According to another embodiment of the invention, communication widget 420 and recipient 300 may establish a direct channel (e.g. peer to peer, or a PSTN voice call). The routing of conversation communication session packets between recipient 300 and communication widget 420 is denoted as step 990.

According to an embodiment of the invention, in step 980 conversation related information (that is responsive to the context metadata) is provided to recipient 300. According to an embodiment of the invention, communication session related information 801 is provided to a third party such as content provider 800.

Referring now to FIG. 2B, in which a similar process in being illustrated, further including echo reduction. In step 961 a first sound sequence is being transmitted to communication widget, following which a returning sound sequence (denoted 964) is transmitted from communication widget 420 to communication system 200, wherein the returning sound sequence usually includes a superposition of first sound sequence echo (denoted 962 and should be reduced) and microphone 194 input. By comparing a first sound sequence parameter and a returning sound sequence parameter, communication system 200 may determine an echo cancellation parameter (denoted 965) that may later be used for reducing of echo in the conversation communication session (denoted as stages 992-996).

According to various embodiments of the invention, the communication widget may be implemented in various ways, e.g. as an ActiveX based communication widget, as a java applet based communication widget, and so forth.

Conveniently, if within a configurable timeout (usually maximum 2-3 seconds) from the transmission of first sound sequence 961, no echo of that audio is found in the audio stream returned from remote system 100, the connection is assumed to have no traceable echo.

It is noted that as part of determining the at least one echo cancellation parameter, the attenuation of different frequency ranges/bands (e.g. which results from effect of different codecs and electronic devices along the route of the signal) can be deducted and saved for tuning of echo cancellation. According to an embodiment of the invention, a spectral diversion (frequency modulation coefficients for different frequency ranges) of the received signal with respect to the transmitted signal can be deducted.

Referring to the process of initiating the conversation communication session between communication widget 420 and communication system 200, communication widget 420 can, according to an embodiment of the invention, retrieve an IP address/host name of an associated communication system 200 (E.g. a server), and an RTMP port of communication system 200—from its configuration or via a DNS service.

According to an embodiment of the invention, communication widget 420 may optionally signal (e.g. via specialized HTTP protocol message) to communication system 200 of its intention to place a RTMP call, wherein communication system 200 may carry out in response of such a notification an echo test. Communication system 200 would usually send a ‘redirect’ response to communication widget 420 telling it to connect to a specified IP/Port different than that of a processing unit (e.g. a server out of a group of multiple servers of communication system 200) which received the initial request. This functionality will help distribute call loads on multiple nodes and can allow for redirecting calls with significant echo (or calls with other characteristics) to specialized nodes which support echo cancellation. Communication widget 420 may at this point attempt to connect to the specified host/port via a RTMP connection initiation request.

According to an embodiment of the invention, after a short configurable timeout (e.g. 500 ms)—in case the initial RTMP message was not answered by the server, communication widget 420 shall attempt an additional connection via RTMPT (RTMP over HTTP) protocol to a port 80 or other suitable port of the indicated host—this will enable a client that is behind a firewall and uses a proxy only connection to communicate with the Internet to test both types of protocols without waiting for a long timeout. After another short configurable timeout (e.g. 500 ms), communication widget 420 shall attempt a third connection attempt via RTMPS (RTMP over SSL) to a port 443 on the same host or other suitable port according to its configuration.

Communication widget 420 than may continue with passing voice media from microphone 194 and playback of media received via RTMP—with the first of the three potential connection (RTMP/RTMPT/RTMPS)—for which it had received a response first—and will conveniently terminate all other connections.

Generally, it is noted that communication widget 420 (or other components of the disclosed system) may be selecting a communications port and protocol for carrying duplex audio signals that form a voice call, between communication widget 420 and communication system 200, by trying to open a few ports and protocols with short timeout between attempts and selection of the first port or connection on which a server has responded.

It is noted that, according to an embodiment of the invention, the conversation communication channel may also be initiated by communication system 200. In such a case, communication widget 420 would usually connect to communication system 200 (usually via HTTP) to indicate it is available to accept calls. A HTTP connection is then kept open between communication widget 420 and communication system 200.

When communication system 200 would like to initiate a server originated call, it may notify then communication widget 420 via a server-generated trigger message encapsulated in HTTP. Communication widget 420 will then generate the media stream and continue in the establishment of the conversation communication session (e.g. according to the call handshake algorithm described above).

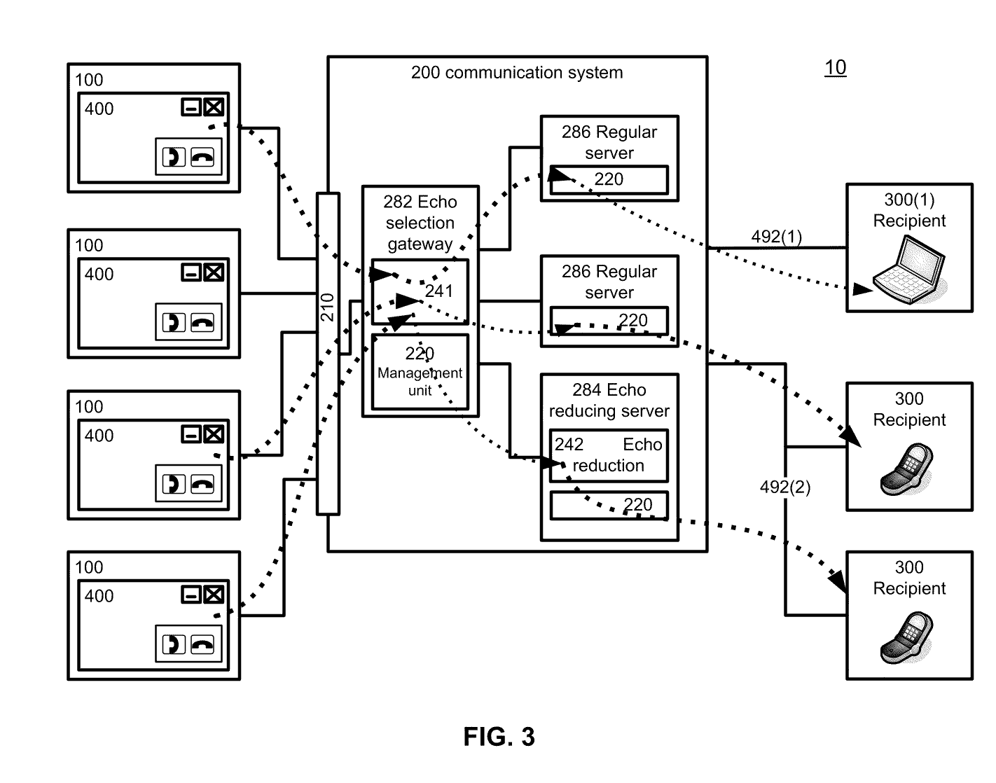

FIG. 3 illustrates system 10, according to an embodiment of the invention. It is noted that, according to an embodiment of the invention, several communication widgets 420 of several remote systems 100 may be connected to communication system 200, and via which to one or more recipients 300. It is also noted that, according to an embodiment of the invention, several recipients 300 may be connected to communication system 200, and communication system 200 may connect between any communication widget 420 to a selected recipient 300 out of the several recipients 300.

It is further noted that, according to an embodiment of the invention, communication system 200 may include multiple processing unit (e.g. multiple processors or processing cores) such as multiple communication servers, that form a structure in which each processing unit is connected to at least one other processing unit.

According to an embodiment of the invention, communication system 200 signal evaluation unit 241 that is configured to evaluate a sound quality of voice communication with remote system 100 is included in a gateway of communication system 200 (E.g. echo selection gateway 282), and wherein the management unit is further configured to select a processing unit that will participate in a routing of the conversation communication session in response to a result of the evaluating, wherein different processing unit of the communication system have different sound processing capabilities.

It is noted that communication system 200 may implement different scenarios and decisions rules for determining an identity of recipient 300, a preferred way to connect to recipient 300 (e.g. try office VoIP software, then cellular number, then home phone number). Communication system 200 may also implement different scenarios and deciding rules for determining what to do if recipient 300 can not be reached (e.g. leave a voice message, leave a text message, and so forth).

According to an embodiment of the invention, communication system 200 is further configured to determine problems in the conversation communication with remote system 100 (e.g. not receiving voice signals at all) and to make any one of the above decision in response to the identification of such problems. According to another embodiment of the invention, communication widget 420 is adapted to determine (or to participate in determining) of communication problems with communication system 200, and to inform communication system 200 about such problems, so that a solution or an alternative communication method may be used.

According to an embodiment of the invention, communication widget 420 (or communication system 200) will attempt to identify common problems that affect its ability to allow the user of remote system 100 to use microphone 194 and/or speakers 192 for generating a voice communication channel (e.g. VoIP call). For example, such common situations include:
Lack of sound card installed.
Sound card malfunction.
No detectable microphone signal (can be the result of a malfunctioning microphone, no microphone present, or a microphone volume which is badly configured). This can be detected, for example, by measuring a gain of the incoming signal (low gain may indicate no active microphone. In order to assure that the user talks, the user may be requested to say his name, etc.)
Other hardware/peripheral related issues such as main system volume low or muted faulty headset (combined earphones and microphone), etc.

When identifying such a situation (for instance by tracking a few seconds of microphone signal and verifying the signal does not present any detectable audio gain)—communication widget 420 may decide on an alternate option for generating voice communications with the other party, or let the user of remote system 100 decide (e.g. by presenting several alternatives).

According to an embodiment of the invention, communication system 200 includes a PSTN port (SIP/ATM port) for communication with the user of remote system 100 (either in an alternative way via remote system 100, or via another system such as a legacy telephone). A possible solution for voice communication problems may then be to present an access telephone number (MSISDN) which directs calls to a PSTN port (SIP/ATM port) of communication system 200, together with a uniquely generated access code which should be entered by the dialing user's dial pad. Such an access code, when dialed by the calling user, would enable communication system 200 to uniquely identify the other party and the context metadata that are pointed to by conversation trigger 410 that the user had clicked on.

As an additional alternative, when a VoIP cannot be generated due to technical limitations or problems, as described above, communication widget 420 can offer the user the possibility to enter a phone number to be called back on, or may attempt to initiate a chat conversation with the user (automatically, or by offering the user this alternative).

After receiving the user's input, communication system 200 shall attempt to connect and bridge recipient 300 and the user who will have placed their phone number for call back.

According to an embodiment of the invention, another solution would be to refer to user of remote system 100 to leave a voice mail as backup. It is optional that communication system 200 will be able to direct calls (whether originating from communication widgets 420 or received via incoming PSTN or external VoIP ports) to a voice mail system, where the user who makes the call would be able to leave a voice mail that will later be sent to or retrieved recipient 300.

As an alternative, when recipient 300 cannot be contacted, the user can be directed to a user interface which allows leaving a text message and a phone number to call back. Such text message may be sent to recipient 300 by email/SMS notification or any other notification means, and can also be viewable as a call record via a call management application (e.g. one that is offered by a central communication management module).

According to an embodiment of the invention, communication system 200 supports a flash based ‘in page’ chat communication widgets 420. According to an embodiment of the invention, communication widget 420 may allow the user of remote system 100 to initiate a chat session that is answered/maintained on the other end by recipient 300. The chat session conveniently takes place within the same communication widget 420 and without leaving the webpage that the call originates from.

As noted above, in some situations webpage 400 in which communication widget 420 is displayed may be closed before a termination of the conversation communication channel is desired (e.g. mistakenly). In order to overcome this issue, in case the user navigates away from webpage 400 during an active voice call (or other type of conversation session), the following solution shall may applied: (a) the navigation in progress shall be identified by a JavaScript event handler that will be embedded in the code of webpage 400; (b) the JavaScript handler will communicate with communication widget 420 and notify it that a navigation away from webpage 400 is imminent; (c) communication widget 420 will notify communication system 200 that a disconnection and reconnection is imminent; (d) a popup browser window with a special HTML document that contains only a communication widget and supportive JavaScript code; (e) the communication widget 320 that is being ‘navigated out’ will notify the newly created communication widget instance that it should pick up an existing call in progress, and terminate its connection with communication system 200; (f) communication system 200 will wait for a configurable timeout for a reconnection of the newly created communication widget. In the meanwhile, the recipient 300 shall conveniently remain connected to communication system 200 and placed on hold. Conveniently, the newly created communication widget instance shall connect to communication system 200 with identification information identical to the destroyed communication widget 420.

Communication system 200 will usually be configured in such an embodiment of the invention to identify the new incoming connection as a handover re-connection and will bridge recipient 300 who have been placed on hold with the newly created communication widget. The user who navigates away from web-page 400 may continue navigating at will and continue their voice conversation in parallel, until terminating the conversation using a user interface of the newly created communication widget, or by closing the specially formed popup window.

According to an embodiment of the invention, communication system 200 is further capable of connecting communication widget 420 to an IVR system via a PSTN or VoIP trunk, and to signal a pre-configured plan of DTMF tones for selecting a pre-programmed set of IVR menu selection on the remote IVR system (and or to automatic execute a pre-configured IVR DTMF/pause script that is executed, e.g. while placing a VoIP client on hold, wherein the selection of such IVR DTMF script configuration may or may not be related to the call's associated Web Context). For example, communication system 200 may determine, in response to the context metadata, that the sequence 2-4-4 should be used for navigating through the IVR system, and that communication widget 420 should vocally communicate with a recipient 300 that is reached by the sequence 2-4-4.

Therefore, according to such an embodiment of the invention, communication system 200 may enable users calling from different web-pages 400 of a certain website (as an example) to be connected directly to different departments or different queues in the call center that is operated by the website owner, and to save the time and bother of traversing IVR DTMF dial menus from the calling user, while reducing false calls to the wrong departments/services on the end of the advertiser or website owner.

According to an embodiment of the invention, system 200 may further instruct the web-browser of remote system 100 to display a different web-page, e.g. to browse to a pre-configured or ad-hoc URL. According to an embodiment of the invention, system 200 may do so using DTMF codes submitted during a voice call, or using specialized string token embedded by a mobile recipient of SMS in a chat-to-SMS session.

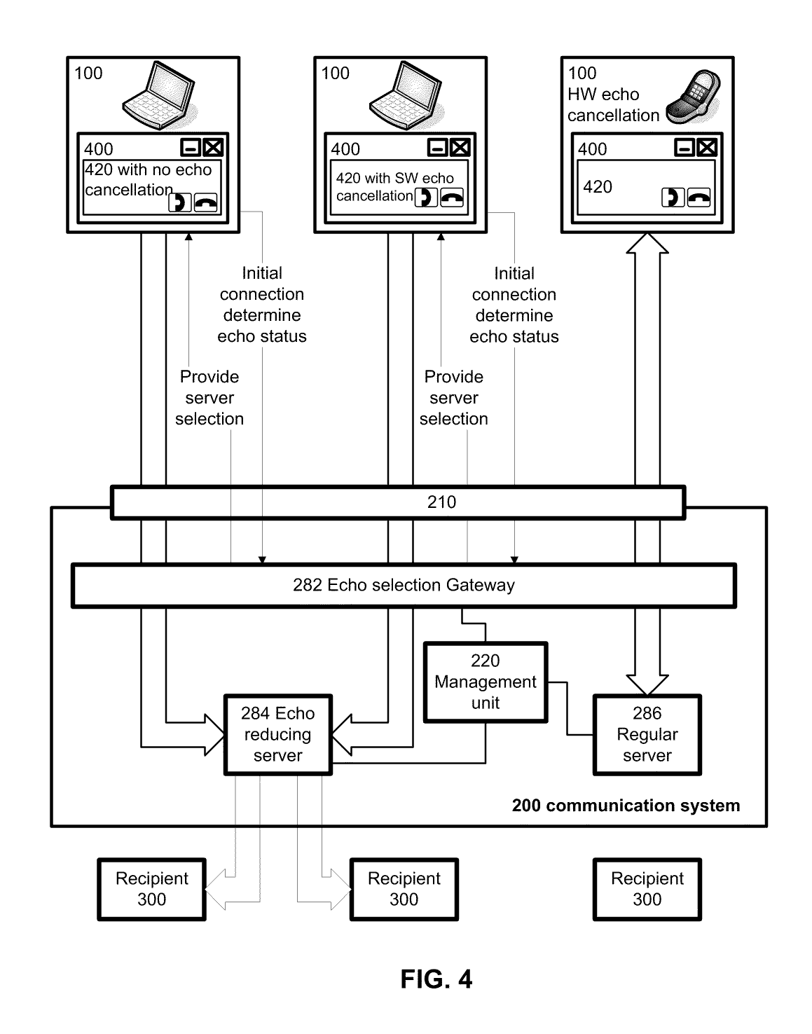

FIG. 4 illustrates a selection of a communication server (e.g. servers 286 or 284) out of a plurality of servers of communication system 200, according to an embodiment of the invention. Conveniently, the selection is based on an evaluation of a sound quality of voice of video communication with remote system 100 (e.g. by signal evaluation unit 241), such as existence (or lack of) echo. It could be seen that, according to an embodiment of the invention, if remote system 100 includes hardware echo reduction modules (or even software or firmware ones, e.g. which are built into the system), conveniently no evaluation of echo needs to be carried out. According to an embodiment of the invention, once the processing unit (e.g. communication server) has been selected, communication widget 420 is being informed accordingly. It is noted that communication server with other signal processing capabilities which are known in the art may be used wherever echo reducing servers 284 are disclosed.

As aforementioned, according to an embodiment of the invention, communication system 200 is adapted to implement echo cancellation or echo reduction. According to an embodiment of the invention, the following algorithm is used for echo reduction:
Communication system 200 (or a processing unit, e.g. a communication server, of which) will add a timestamp (e.g. based on internal clock) as a protocol header field, to each voice chunk/packet that is transmitted from communication system 200 to communication widget 420.
Communication system 200 will maintain a data structure containing the timestamps of all packets it will have transmitted to communication widget 420. For each packet, communication system 200 will also store at least one sound related parameter (e.g. the total gain) pertaining to the audio transmitted from the communication system 200 to communication widget 420.
The communication widget 420 will write the LAST timestamp it has received (that would be the time of transmitting the packet according the clock of communication system 200) into the header of each chunk/packet of voice data it sends back to communication system 200.
Communication system 200 will examine the timestamp that appears in the header of each audio packet that is received from the communication widget 420.
Communication system 200 will retrieve the at least one sound related parameter from its data structure, based on the time of packet transmission that will be extracted from the incoming packet's header. Communication system 200 will then modify a sound parameter of the sound sequence of the packet, e.g. by lowering the packet's gain by the same amount, before passing that packet or chunk of audio data to recipient 300.

According to an embodiment of the invention, communication system 200 is configured to implement jitter correction. Communication system 200 will, according to such as embodiment of the invention, identify jitter (breaks in incoming audio stream) in the incoming signal from the direction of communication widget 420. An adaptable sized delay buffer will be implemented in communication system 200, to avoid jitter. According to an embodiment of the invention, communication system 200 is configured to change the size of the buffer to a sufficient size to overcome jitter.

According to an embodiment of the invention, communication system 200 is configured to implement automatic gain tuning. According to such as embodiment of the invention, communication system 200 will modify gain of audio streams that path through, in an attempt to achieve a human acceptable gain level heard by both parties of each call.

According to an embodiment of the invention, communication system 200 implements (includes or is connected to) a back office call management application. This application conveniently enables persons (such as website owners/operators, advertisers, owners of classified ads, and other users) the ability to configure, manage, track and analyze the calls they receive from Internet users via the conversation triggers 410, communication widgets 420, and so forth.

Conveniently, the back office call management application is a web-based application that can be hosted on centrally operated websites or integrated as part of the user workflow of partner websites. According to an embodiment of the invention, the back office call management application serves a group of recipients 300 (e.g. sales representative of a company). According to an embodiment of the invention, a recipient communication widget may be used for receiving calls. According to such as embodiment of the invention, users can receive calls via recipient communication widgets embedded in a call management application.

Different users that all belong to the same organization, and to which a single (or a ground of) communication triggers is defined to route calls, can all receive calls in turns (similar to a call center queue) when logged into the back office application—via the recipient communication widget embedded in the back office application. It is noted that the back office application may be at installed, according to an embodiment of the invention, on a server of a recipient entity (e.g. the company employing the sale representatives), on communication system 200, or elsewhere.

When receiving an incoming call, the call management application will conveniently display the conversation related information in parallel to audibly and visually notifying the user of the incoming call (i.e. the call's origination in terms of web URL and location and other metadata, together with any data that is collected by communication system 200 regarding the calling user, and/or remote system 100, will be presented in a popup window).

According to an embodiment of the invention, recipients 300 can receive calls via mobile phone or landline. When a recipient 300 answers such an incoming call, communication system 200 can read a notice identifying the call's web context via a text-to-speech engine (e.g. ‘you got a call from your sponsored yellowpages.com listing’) and recipient 300 is then prompted, for example, to accept the call, reject it or forward it to another queue member via an IVR DTMF menu.

According to an embodiment of the invention, recipients can receive calls from communication system 200 via a PSTN line/call center queue. Such incoming calls can be connected to any PSTN line including incoming access numbers of call centers. The call center management application can display information regarding the call's origin and web context via data integration between communication system 200 and the call center server.

According to an embodiment of the invention, recipients 300 who are users of the back office application, can call back users who tried to call via a conversation trigger 410 and their call didn't get through, was not answered, was referred to voice mail, or cancelled by recipient 300.

Such recipients 300 can view a list of such incomplete calls as part of the call management application, and can request to call such users back. According to an embodiment of the invention, when a user working on the same remote system 100 enters the web-page 400 again (or views another instance of the same banner ad campaign), communication system 200 may initiate a voice call or other type of conversation communication with a communication widget 420 that is supplied to remote system 100, that is embedded in the webpage or banner presently viewed by the user (or launched by that webpage or banner).

In case the calling user has used PSTN call-back or call-through options of the communication widget 420, communication system 200 may, according to an embodiment of the invention, trigger a PSTN call to the stored MSISDN for that user without having to wait for the user's return to the same website or banner ad campaign.

According to an embodiment of the invention, communication system 200 may initiate a call with a web visitor. According to an embodiment of the invention, the call management application can be used to initiate calls to website visitors. The system track website visitors that are currently viewing website 400 that hosts conversation triggers 410 and lists users that are presently visiting the site and their exact location in terms of URL.

The call management application user (usually a recipient 300) can then order communication system 200 to trigger a voice call (or other type of conversation communication) with a communication widget 420 embedded in the webpage 400 presently displayed to the visitor.

According to an embodiment of the invention, communication system 200 supports conducting chat sessions via communication widget 420. According to an embodiment of the invention, call management application users (usually a recipient 300) can conduct text chat sessions with web visitors that wish to chat with an operator/advertiser, in any of the following means:
Via a recipient communication widget embedded in the call management application.
Via market acceptable chat/IM software such as AIM, ICQ, MSNIWL Messenger, Skype, GTalk and so on. Communication system 200 and the call management application can be configured to forward chat sessions addressed for specific accounts into user accounts of third party IM software.

According to an embodiment of the invention, recipients can ask to forward chat sessions to/from SMS via a mobile phone. According to an embodiment of the invention, a web visitor can initiate a chat session by clicking a conversation trigger 410 placed on a webpage, and enters some chat text into the designated user interface that is part of the communication widget 420. According to an embodiment of the invention, communication system 200 can retrieve a phone number capable of receiving SMS, that is associated with the conversation trigger 410, and sends the chat text entered by the web visitor to that phone number as a SMS.

The SMS is sent from a MSISDN (caller ID) that is selected by communication system 200 from a pool of caller IDs and associated with the active chat session out of a pool of available caller IDs that is pre-configured at communication system 200. Optionally the caller ID can be obtained in real time for each chat session from a partner PSTN carrier who manages a pool of such phone numbers. The MSISDN selected for the first SMS/chat text is uniquely associated to a single the chat session with an expiration timeout that allows reusing the same MSISDN for different sessions after its expiration.

When the user who received the SMS would like to reply to the chat, they may send an SMS back to its originator caller ID (MSISDN) and communication system 200 would receive SMS messages sent to that number via its integration with a mobile carrier.

According to an embodiment of the invention, communication system maps the SMS received to an ongoing chat session, using the incoming called ID MSISDN to which the SMS was sent by the mobile user, and forwards the contents of the SMS to the web visitor as a ‘chat line’ that appears in the communication widget 420's chat user interface.

The process can repeat itself for each new ‘chat line’ and ‘chat line response’ thus enabling web visitors to chat with an operator or representative via a chat to SMS to chat conversation.

Likewise, according to an embodiment of the invention, recipients can conduct chat sessions with web visitors via a phone call text to speech+speech to text solutions.

According to an embodiment of the invention, communication system 200 is able to manage a queue of recipients 300 that belong to the same account/organization and distribute chat requests arriving from associated conversation triggers 410 to a queue of operators.

According to an embodiment of the invention, communication system 200 may participate in controlling remote system's browsing and presenting pre-defined content using a conversation. According to such an embodiment of the invention, communication system 200 allows website operators/advertisers that are engaged in an active chat or call session with a web visitor, to influence the browsing and navigation of the visitor. This capability can be used to allow website operators or advertisers to direct visitors to contents of interest to them or relevant sections of the website being displayed. While in a chat or call session, recipient 300 can conveniently navigate the user's browser to pre-defined URLs, via the following means:
Command buttons and options in the call management application user interface. Using the call management application the recipient can direct the initiator's web browser to pre-programmed URL or to an ad-hoc URL entered by the recipient during a call or session.
Using pre-programmed set of DTMF commands when the advertiser/website operator is engaged in a voice call via a PSTN mobile or fixed phone. (e.g.—dialing the digits ‘# followed by 4’ can be programmed to direct the web visitor to a specific product or service page during a call).
Using specialized pre-programmed tokens embedded in SMS messages when chatting with a web visitor via chat to SMS (e.g. insert a specially formatted string such as $01$ at the end of an SMS message to open a new browser window with a pre-designated URL—for instance a registration form for a job seeking web site).

It is noted that conversation triggers 410 and conversation widgets 420 may be integrated with web-pages 400 in different ways, according to different embodiments of the invention. For example (note that conversation triggers 410 may be implemented the same ways):
Adding the conversation widget 420 as a floating hidden DIV and triggering it from the page
Communication widget 420 includes a combination of JavaScript code, HTML code and a flash applet that handles the conversation communications.
The communication widget 420 is inserted into websites by injecting a few lines of JavaScript code, that in turn includes JavaScript programs that carry out the following functions:
Modify in run time the HTML document to include a floating or fixed DIV tag that contains one or more conversation triggers 410 according to the configuration stored in communication system 200s mapped to the website's domain or URL.
Load the communication widget 420—which is a mixture of HTML/DHTML code, JavaScript code and flash (SWF) files onto a hidden DIV that is dynamically injected into the loaded HTML document.
This method of integration allows users with minimal or no technical know-how to quickly integrate communication triggers and communication widgets in websites and web-pages.

According to an embodiment of the invention, the invention also includes auto-replacing phone numbers in HTML documents with conversation triggers 410. This may be implemented by a supplied line of JavaScript code that can be easily inserted into HTML pages or content management system that create HTML pages for display based on dynamic contents.

The JavaScript code runs as a client-side script by the web browser software that the user uses to browse web pages. The code reads the HTML document after it is loaded, and replaces telephone numbers that appear as part of the webpage text, with conversation triggers 410 that allow the user to place a voice call that is directed to the phone number that was replaced by the trigger.

The process flow for identifying and replacing phone numbers that appear in HTML pages with conversation triggers 410 is as follows:

After HTML document is loaded, look for sequences of numbers that correspond to common telephone numbering templates (i.e. 03-555-5555/03-5555555/+972-3-5555555/+(972) 3 5555555—etc.). There are a few dozen formats that represent phone numbers in different notations and countries.

If the number is adjacent to a text indicating ‘fax:’ or ‘fax’, the software assumes it is a fax number and does not replace it with a conversation trigger 410.

The number is normalized to a MSISDN format (i.e. 03-5555555 will become when in Israel +97235555555). Local numbers are assumed to be located at the country in which the website hosting the HTML document resides (the country can be deduced from the webpage's IP address).

The client-side java script code sends a lookup query to communication system 200 via AJAX communications, for each MSISDN discovered in the processed HTML. Communication system 200 will reply which of the MSISDN's to translate to conversation triggers 410. This allows communication system 200 to provide dedicated services to select groups of users/advertisers—identified by their phone numbers.

Communication system 200 replies with an identification of each receiving party which uniquely identifies that party in the database (it would be a number or string which is different from the party's phone number).

The client-side java script code then re-writes the HTML document, remove phone numbers that were indicated for replacement by communication system 200, and insert a HTML code portion that creates a conversation trigger 410 with the unique identifier received from communication system 200—instead of each phone number marked by communication system 200 for replacement.

The result of this process is a modified HTML document that include conversation triggers 410 instead of some or all of the phone numbers which appear on the original document—configured with unique IDs that correspond to the same phone numbers in the database. This allows the end user to call the ‘converted’ numbers directly from the webpage (using communication widgets 420)—without having to copy the number and dial via mobile/fixed line or use external VoIP call software to place the calls.

The solution enables Directory Publishers and Classified ad websites to provide conversation capabilities to some or all of the advertisers and listings that all appear on the same webpage, by embedding a single line of JavaScript code in the HTML code of such pages.

As aforementioned, according to an embodiment of the invention, communication widget 420 may be embedded in an internet advertisement (e.g. an image, text or rich media file embedded in an HTML document, that advertises a product or service that is displayed in the context of a host media/webpage), to generate voice calls or other types of conversation communication to entities such as the advertiser or to its agents, representatives, access phone numbers, or call centers, without asking users to input their phone numbers and without requiring users to be familiar with advertiser's access numbers/phone numbers—by issuing a single mouse click over the internet advertisement or a designated region within it.

According to an embodiment of the invention, communication widget 420 which may be launched from an internet advertisement upon receipt of a user's mouse click (or fly over of the mouse) on the internet advertisement or a designated region of it—and may allow calling an individual advertiser or advertiser organization in a method similar to the above.

According to an embodiment of the invention, communication widget 420 (that may, as aforementioned, be a Flash based communication widget) may facilitate a voice call or other type of conversation communication with an individual advertiser or advertiser organization when an internet advertisement is loaded or upon other noticeable events not necessarily derived from user input. According to an embodiment of the invention, the triggering of conversation trigger 410 may be responsive to an event other than a user initiated event.

It is noted that, according to an embodiment of the invention, communication system 200 may connect two communication widgets 420 of different remote systems 100, which may either display the same web-page 400, or other web-pages, usually upon receiving an indication of willingness of at least one of the users (recipient 300) to accept calls from various websites/webpages.

According to an embodiment of the invention, the conversation trigger 410 may be a video application, applet, or widget (or may be embedded in such video entity) that is adapted to display video, wherein a content of the video is associated with one or more collections of context metadata, wherein the pressing of the video (conveniently substantially when the associated content is displayed) results in sending the conversation imitation request that includes the respective content metadata. For example, a clicking a person who appears in an internet video (weather archived video contents or video file or a live broadcast of a video stream) may result in initiating a voice communication with that person. According to an embodiment of the invention, conversation trigger 410 may facilitate generating a call from webpage 400 that hosts the video file or video stream to the recipient 300 who is the person who participates in the video.

According to an embodiment of the invention, when clicking the person who appears in the internet video, the conversation trigger 410 enables generating a call from webpage 400 that hosts the video file or video stream to an advertiser who sponsors the video or sells a product or service which are displayed as part of the video content.

According to an embodiment of the invention, communication system 200 may implement a pre-configured server application to place calls that originate from different webpages 400 into different queues of an organization's call center—by either connecting calls from different webpages 400 to different PSTN access numbers or by connecting some or all calls to the same access number and automatically issuing IVR commands via DTMF to the remote call center/IVR application in order to route calls that originate from different webpages 400 or web contexts into different incoming call queues or departments in the same call center or organization.

As aforementioned, according to an embodiment of the invention, communication system 200 is configured to cancel (or at least reduce) echo in VoIP calls based on correlation of timestamp and gain values that are injected by a server into its transferred media stream, with the same timestamps/gain values that are copied by a VoIP client (communication widget 420) from its received media stream (the server's transmitted stream) into the client's transmitted stream (the server's received stream)—as further detailed above.

Referring to chat communication as disclosed above, it is noted that, according to an embodiment of the invention, communication system 200 is configured to manage a chat session between remote system 100 and recipient 300, wherein at least one of the parties may be handled by a third party widely acceptable chat application (ICQ, GTalk, AIM, MSN) or via Chat-To-SMS or Chat-To-Voice (as further detailed above).

It is noted that, according to an embodiment of the invention, recipient 300 can be the one initiating the conversation communication with a user of remote system 100, usually upon consent of the user. For example, if a user is know to spend over several minutes in a sales page of a certain product, a sales representative may offer the user to receive a live audio assistant. According to an embodiment of the invention, first network interface 210 is further configured to receiving from remote system 100 a user attention indication pertaining to a viewing of web page 400 by the user (e.g. as discussed above, but not necessarily so); and to receive from recipient 300 (or from an entity associated with which such as a communication center of an organization) a recipient conversation request that is responsive to the user attention indication. System 200 may than, according to an embodiment of the invention, initiate conversation with the remote user and the recipient that is triggered by the system instead of by a specific user triggering of the call action).

Usually, the receiving of the recipient conversation request is preceded by providing to recipient 300 (or to the entity associated with which) the recipient conversation request. According to an embodiment of the invention, conversation trigger 410 is configured to identify a user attention situation, and to provide to communication system 200 the user attention indication accordingly. The user attention indication received from remote system 100 than serves as a conversation initiation request, but which usually requires additional request from the other party, as well as additional approval from the user.

According to an embodiment of the invention, communication system 200 includes one or more first network interface 210, wherein the at least one first network interface 210 is for receiving multiple conversation initiation requests from conversation triggers 410 that are included in at least one web page 400 that is displayed in multiple remote systems 100, wherein the management unit 220 is further configured to initiate the conversation communication session between at least two remote systems 100 of the multiple remote systems 100. For example, this may be used in scenarios when user would like to converse with any user out of a group of users (e.g. a help-line), and in other situations as well.

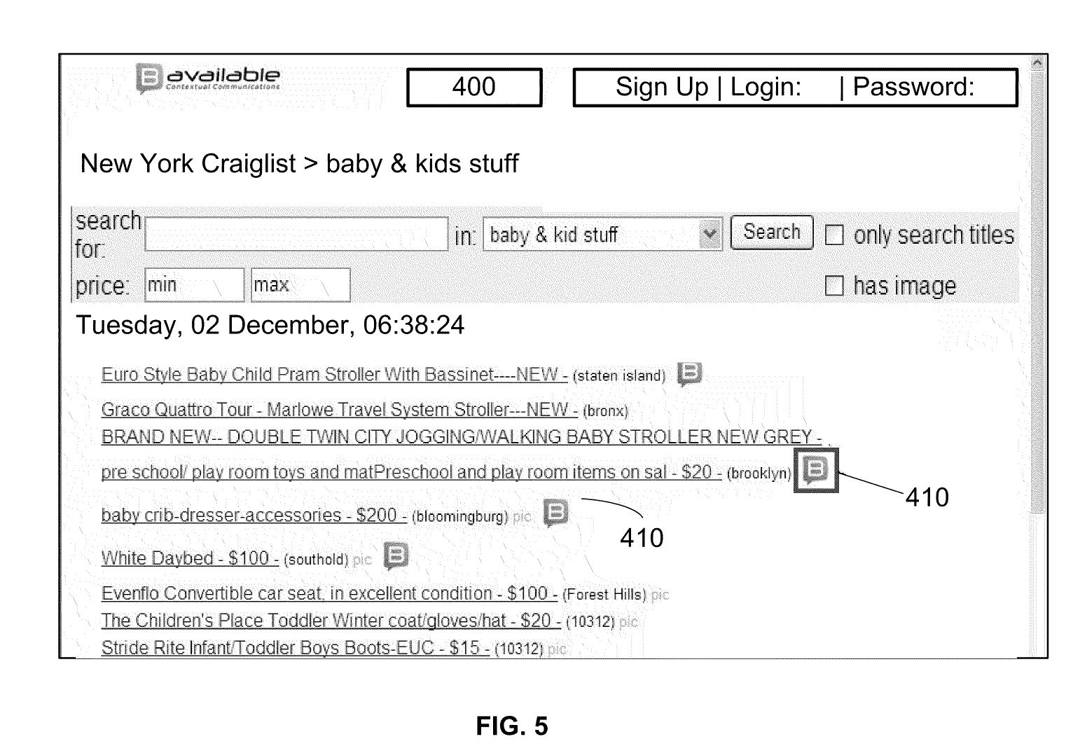

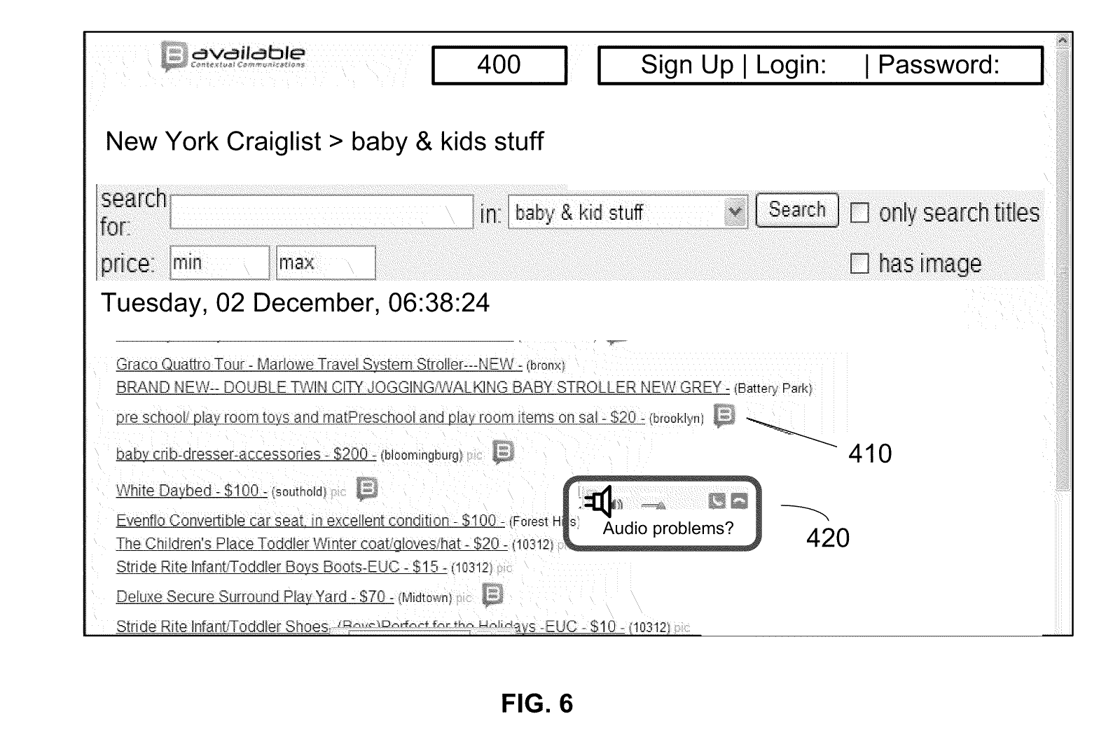

FIGS. 5 and 6 illustrate displays of a web-page 400, according to an embodiment of the invention. In FIG. 5 several conversation triggers can be seen, and FIG. 6 illustrates the same web-page 400, when a triggering of one of the conversation triggers 410 have resulted in an including of a communication widget 420 in the same web-page.

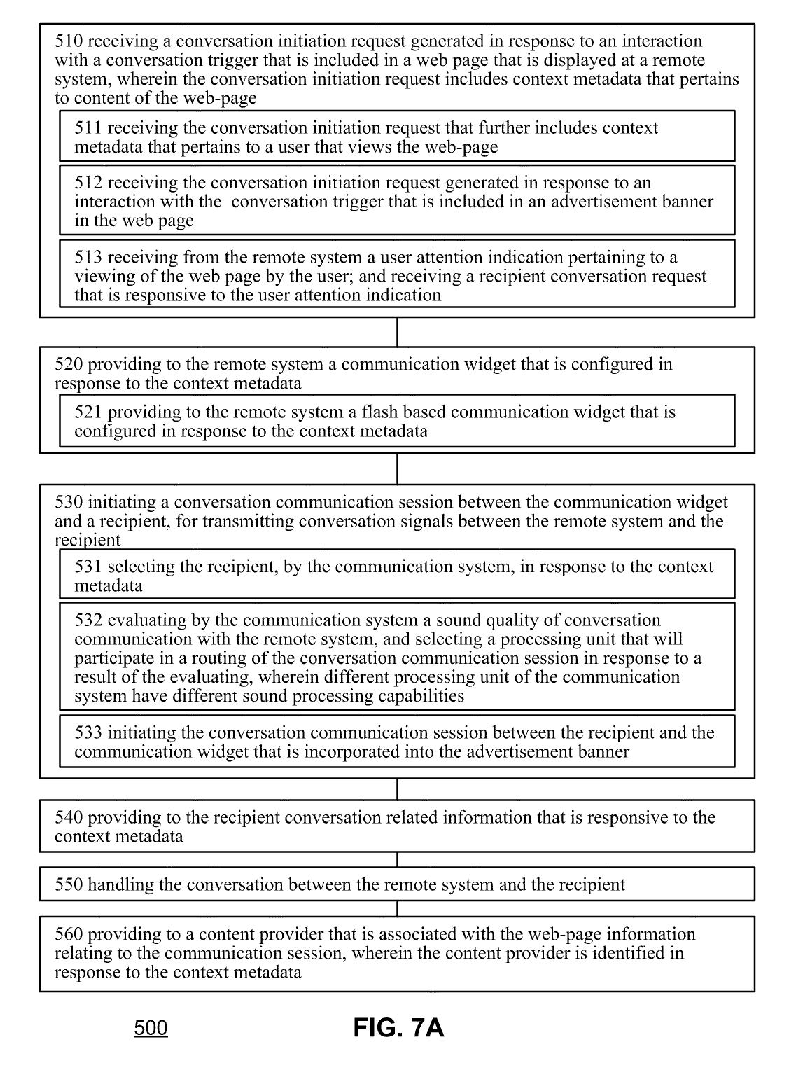

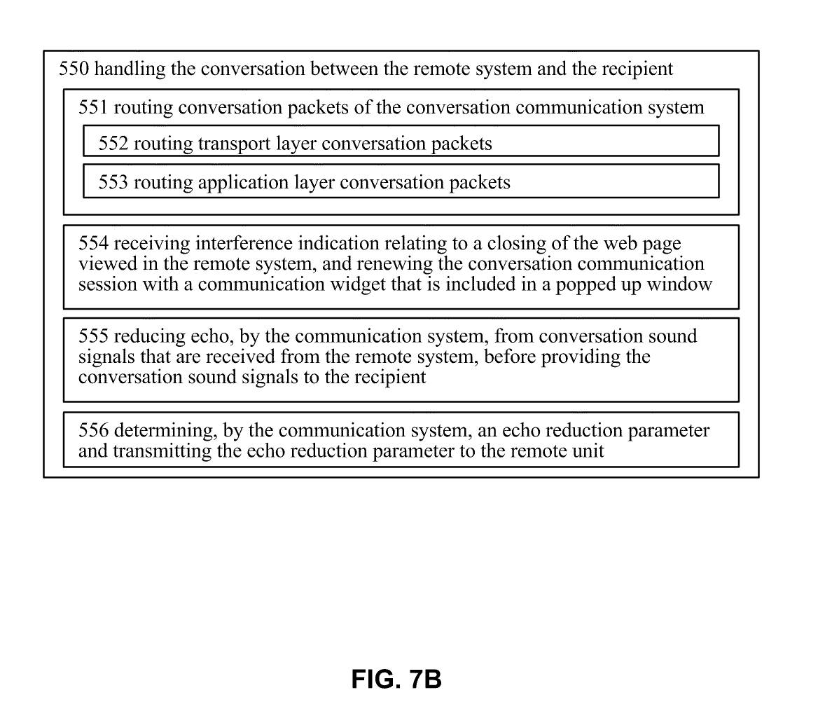

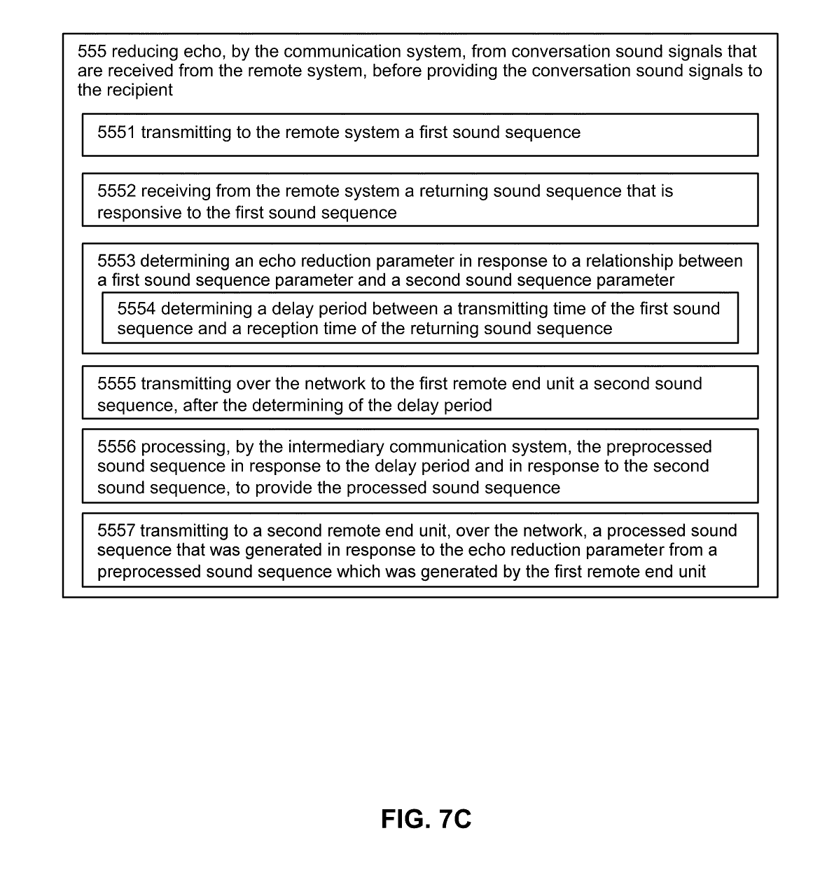

FIGS. 7A through 7C illustrate method 500 for providing communication, according to an embodiment of the invention. It is noted that conveniently, the different steps of method 500 are carried out by a single communication system unless otherwise stated. Such a communication system may be a group of one or more communication servers (e.g. system 200) that is connected by a network to a remote system (e.g. a computer of a user) and is also connected by a network to a recipient.

It is noted that different embodiments of method 500 may be carried out by the aforementioned different embodiments of communication system 200, and that different embodiments of communication system 200 implement different embodiments of method 500, even if not explicitly stated.

It is further noted that according to different embodiments of the invention, only some of the steps of method 500 may be carried out, and specifically, different sub-steps of a single steps (e.g. sub steps 511, 512, and 513 of step 510) may be all carried out, or alternatively only some or none of the sub-steps are carried out.

Method 500 conveniently starts with step 510 of receiving a conversation initiation request generated in response to an interaction with a conversation trigger that is included in a web page that is displayed at a remote system, wherein the conversation initiation request includes context metadata that pertains to content of the web-page. It is noted that the initiation request may be generated by the conversation trigger itself, or by another module (e.g. a web browser) which receives indication pertaining to the interaction. As aforementioned, the interaction may be of a user of the remote system, or of another party such as (though not limited to) a recipient of the voice conversation.

Referring to the examples set forth in the previous drawings, the receiving is conveniently carried out by first network interface 210, and the conversation trigger is conveniently conversation trigger 410 that is included in web-page 400.

According to an embodiment of the invention, step 510 includes step 511 of receiving the conversation initiation request that further includes context metadata that pertains to a user that views the web-page (e.g.—a user's login credential, a user's level of authorization or service provisioning, a user's history of URLs visited by user that is stored in the server—including associative context of visited URLs (e.g. user visited sites related to French books based on keywords extracted from the past pages).

According to an embodiment of the invention, step 510 includes step 512 of receiving the conversation initiation request generated in response to an interaction with the conversation trigger that is included in an advertisement banner in the web page, or which is launched by the advertisement banner.

According to an embodiment of the invention, step 510 includes step 513 of receiving from the remote system a user attention indication pertaining to a viewing of the web page by the user, wherein the initiating is preceded by receiving a recipient conversation request that is responsive to the user attention indication. According to such an embodiment of the invention, method 500 may further includes initiating a conversation with the remote user and the recipient that is triggered by the system instead of by a specific user triggering of the call action. According to an embodiment of the invention, the initiating of the conversation may include initiating conversation communication with a website visitor who is browsing a web-site that embeds a widget (e.g. a flash-based widget) that supports server-initiated calls. Such call may be triggered from a management application that displays a list of current website visitors to its operator.

Step 510 is followed by step 520 of providing to the remote system a communication widget that is configured in response to the context metadata. Referring to the examples set forth in the previous drawings, the communication widget is conveniently communication widget 420.

It is noted that the providing of the communication widget may include, according to different embodiments of the invention, providing communication widgets that are implemented in various ways. For example, according to various embodiments of the invention, the providing may include providing an ActiveX based communication widget, and/or a java applet based communication widget.

According to an embodiment of the invention, step 520 includes step 521 of providing to the remote system a flash based communication widget.

Step 520 is followed by step 530 of initiating a conversation communication session between the communication widget and a recipient, for transmitting sound signals (or video signals, or chat signals, etc.) between the remote system and the recipient.

According to an embodiment of the invention, step 530 includes step 531 of selecting the recipient, by the communication system, in response to the context metadata. It is noted that, according to different embodiments of the invention, the recipient may be selected by different parties (the recipient itself or an entity associated with which, the remote system, an external system, and so forth). According to an embodiment of the invention, the selecting may include selecting the recipient's audio enabled address such as E.164 MSISDN, SIP ID, Skype ID etc., selecting the recipient's video conversation enabled address, PSTN number, chat enabled address, and so forth.

According to an embodiment of the invention, step 530 includes step 532 of evaluating by the communication system a sound quality of conversation communication with the remote system, and selecting a processing unit that will participate in a routing of the conversation communication session in response to a result of the evaluating, wherein different processing unit of the communication system have different sound processing capabilities.

According to an embodiment of the invention, step 530 includes step 533 of initiating the conversation communication session between the recipient and the communication widget that is incorporated into the advertisement banner of step 512 (or that is launched by that advertisement banner). It is noted that even if step 512 is carried out, the communication widget is not necessarily incorporated into that advertisement banner.

According to an embodiment of the invention, method 500 further includes step 540 of providing to the recipient conversation related information that is responsive to the context metadata. It is noted that the providing of information to the recipient may be carried out before, during, or after the conversation communication session. For example, the providing of stage 540 may include announcing the web context associated with a call via a text to speech module or playback of a recorded message, e.g. immediately after the called party answers a call that originates from a webpage or banner.

According to an embodiment of the invention, method 500 further includes step 550 of handling the conversation between the remote system and the recipient. It is noted that while the conversation may be handled by the communication system, it may also be handled, according to different embodiments of the invention, by other systems. Different sub-steps of step 550 (which are implemented in different embodiments of the invention) are illustrated in FIG. 7B.

According to an embodiment of the invention, step 550 includes step 551 of routing conversation packets of the conversation communication session.

According to an embodiment of the invention step 551 includes step 552 of routing transport layer conversation packets (e.g. TCP packets, such as according to a raw RTMP standard). According to an embodiment of the invention, step 551 includes step 553 of routing application layer conversation packets (e.g. HTTP packets, such as in the RTMPT and RTMPS standards). It is noted that step 551 may also include selecting the types of conversation to be routed (e.g. in response to identifying of a fire wall, and so forth).

According to an embodiment of the invention, method 500 further includes step 554 of receiving interference indication relating to a closing of the web page (by user or by code) viewed in the remote system, and renewing the conversation communication session with a communication widget that is included in a popped up window. It is noted that step 554 may be carried out when communication system 200 handles the conversation, but also if an external system handles the conversation.

According to an embodiment of the invention, step 550 further includes step 555 of reducing echo, by the communication system, from conversation sound signals that are received from the remote system, before providing the conversation sound signals to the recipient. Reducing echo according to different embodiments of the invention is disclosed in more details below, in relation to FIG. 7C, and in US patent application entitled “Methods and systems for voice communication” filing date Jun. 30, 2009, that is incorporated herein by reference.

According to an embodiment of the invention, method 500 further includes step 556 of determining, by the communication system, an echo reduction parameter and transmitting the echo reduction parameter to the remote system, wherein method 500 further includes receiving from the remote system a sound sequence that is generated by the remote system in response to the echo reduction parameter.

According to an embodiment of the invention, method 500 further includes step 560 of providing to a content provider that is associated with the web-page information relating to the communication session, wherein the content provider is identified in response to the context metadata.

According to an embodiment of the invention, method 500 may further include instructing the web-browser of the remote system to display a different web-page, e.g. to a pre-configured or ad-hoc URL. This may be done, for example, using DTMF codes submitted during a voice call, or using specialized string token embedded by a mobile recipient of SMS in a chat-to-SMS session.

Referring now to FIG. 7C, which illustrates step 555, according to an embodiment of the invention. According to an embodiment of the invention, step 555 starts with step 5551 of transmitting to the remote system a first sound sequence; which is followed by step 5552 of receiving from the remote system a returning sound sequence that is responsive to the first sound sequence. Step 5552 is followed by step 5553 of determining an echo reduction parameter in response to a relationship between a first sound sequence parameter and a second sound sequence parameter; which is followed by step 5557 of transmitting to the recipient, over a network, a processed sound sequence that was generated in response to the echo reduction parameter from a preprocessed sound sequence which was generated by the remote system.

According to an embodiment of the invention, the transmitting of the first and the processed sound sequences includes transmitting the sound sequences over at least one asynchronous packet switched network segment.

It is noted that, according to an embodiment of the invention, step 5553 includes step 5554 of determining a delay period between a transmitting time of the first sound sequence and a reception time of the returning sound sequence, wherein step 5557 is preceded by step 5555 of transmitting over the network to the remote system a second sound sequence, after the determining of the delay period; and wherein method 500 further includes step 5556 of processing, by the intermediary communication system, the preprocessed sound sequence in response to the delay period and in response to the second sound sequence, to provide the processed sound sequence.

It is noted that, according to an embodiment of the invention, the receiving of step 510 includes receiving multiple conversation initiation requests from conversation triggers that are included in at least one web pages that is viewed in multiple remote systems, wherein the initiating of step 530 includes initiating the conversation communication session between at least two remote systems of the multiple remote systems.

It is noted that, according to an embodiment of the invention, the initiating includes initiating the voice communication session between the communication widget and the recipient which is an advertiser, wherein the communication session is at least partly concurrent to a displaying of an internet advertisement of the advertiser on the remote system. is loaded or upon other noticeable events not necessarily derived from user input.

According to an embodiment of the invention, the initiating is triggered by clicking by a user of the remote system on a person who appears in an internet video. E.g. The communication widget may allow generating a call from the webpage that hosts the video file or video stream to the person who participates in the video.

According to an embodiment of the invention, method 500 may further includes directing, by a pre-configured server application, or via issuing of pre-configured DTMF sequences, voice communication sessions that are initiated in response to conversation initiation requests of different webpages into different queues of an organization's call center, e.g. by either connecting calls from different webpages to different PSTN access numbers or by connecting some or all calls to the same access number and automatically issuing IVR commands via DTMF to the remote call center/IVR application in order to route calls that originate from different webpages or web contexts into different incoming call queues or departments in the same call center or organization.

According to an embodiment of the invention, method 500 further includes asking from a user to speak (e.g. requesting the user to say his name, to read a provided text, or to say any other random text) and analyzing the gain and spectral pattern of the sequence received at the server, in order to determine if a user's microphone is operational and has a valid volume that would enable a reasonable voice communication session.

According to an embodiment of the invention, method 500 further includes providing, if a microphone is not present or deemed not present as a result of low overall gain of the entire received signal, PSTN access numbers and access codes that would allow a user to place a PSTN call, wherein the method further includes routing the PSTN call placed by the user as if it would have been the call the user was trying to trigger by interacting with the conversation trigger.

According to an embodiment of the invention, method 500 further includes providing, if a microphone is not present or deemed not present as a result of low overall gain of the entire received signal, a chat user interface that allows the user to initiate a textual chat session with a remote operator

According to an embodiment of the invention, method 500 further includes requesting, if a microphone is not present or deemed not present as a result of low overall gain of the entire received signal, from a user to enter a phone number; wherein the method further includes calling the phone number via PSTN/VoIP termination services and route that outgoing call to the same route as if it would have been the original call the user is trying to complete by interacting with the conversation trigger.

According to an embodiment of the invention, method 500 further includes selecting a communications port and protocol for carrying duplex audio signals that form a voice call of the voice communication session, between the communication widget and a server, by opening multiple ports and protocols with short timeout between attempts, and selecting the first port or connection on which a server has responded.

According to an embodiment of the invention, method 500 further includes selecting a phone number out of different target phone number, wherein the selecting is responsive to web context that includes the URL of the web-page, a location within active HTML document and additional metadata of the webpage, wherein the method further includes routing the voice communication session into a telephony system using the selected phone number.

According to an embodiment of the invention, the initiating includes automatically executing at least one pre-configured IVR DTMF/pause script by a server while placing a VoIP client on hold. The selection of such IVR DTMF script configuration may or may not be related to the call's associated Web Context.

According to an embodiment of the invention, method 500 further includes presenting to a website operator a list of current website visitors to the website, and initiating a voice communication session with the external system in response to an input received from the operator.

According to an embodiment of the invention, method 500 further includes initiating a chat session with a website visitor who wishes to chat with the recipient, wherein the chat session is handled by a third party widely acceptable chat application (e.g. ICQ, GTalk, AIM, MSN) or via Chat-To-SMS or Chat-To-Voice.

According to an embodiment of the invention, method 500 further includes conducting an online chat session between the remote system and another remote system of another user who wishes to engage in chat sessions.

According to an embodiment of the invention, method 500 further includes controlling a browsing of a browser of the remote system, and navigating the web browser to a pre-configured or ad-hoc URL, using DTMF codes submitted during a voice call. It is noted that the DTMF codes may be submitted by the call recipient, by a server, and so forth.

According to an embodiment of the invention, method 500 further includes controlling a browsing of a browser of the remote system, and navigating the web browser to a pre-configured or ad-hoc URL, using specialized string token embedded by a mobile recipient of short messages service (SMS) in a chat-to-SMS session.

According to an embodiment of the invention, method 500 further includes detecting at least one phone number in the web-page—e.g. detecting the at least one phone number, or any similar communication identifier such as a Skype account, by detecting the phone number in the text of the webpage according to its textual pattern, for example by text analyzer—and translating the at least one phone number into at least one conversation trigger. It is noted that the detecting and/or the translating may be carried out, according to an embodiment of the invention, by an external software component or layer which is external to the web-site's design and implementation (a ‘widget’).

According to an embodiment of the invention, wherein the initiating is followed by announcing a web context that is associated with the voice communication session using a text to speech module or a playback of a recorded message, wherein the announcing is carried out immediately after the recipient accepts the voice communication session.

According to an embodiment of the invention a computer readable medium is disclosed, the computer readable medium having a computer readable code embodied therein for providing communication. The computer readable code includes instructions for: (a) receiving a conversation initiation request generated in response to an interaction with a conversation trigger that is included in a web page that is displayed at a remote system; wherein the conversation initiation request includes context metadata that pertains to content of the web-page; (b) providing to the remote system a communication widget that is configured in response to the context metadata; and (c) initiating a conversation communication session between the communication widget and a recipient, for transmitting conversation signals between the remote system and the recipient.

It is noted that the computer readable medium and code usually implement method 500 a different embodiments thereof, and that different embodiments of communication system 200 may utilize different forms of the computer readable code and/or medium, either by way of software, hardware, or firmware, or any combination thereof.

According to an embodiment of the invention, the computer readable code further includes instructions for providing to a content provider that is associated with the web-page information relating to the communication session, wherein the content provider is identified in response to the context metadata.

According to an embodiment of the invention, the computer readable code further includes instructions for providing to the recipient conversation related information that is responsive to the context metadata.

According to an embodiment of the invention, the computer readable code further includes instructions for providing to the remote system a flash based communication widget.

According to an embodiment of the invention, the computer readable code further includes instructions for routing conversation packets of the conversation communication session, wherein the routing includes routing transport layer conversation packets (TCP, raw RTMP).

According to an embodiment of the invention, the computer readable code further includes instructions for routing conversation packets of the conversation communication session, wherein the routing includes routing application layer conversation packets (HTTP, RTMPT, and RTMPS).

According to an embodiment of the invention, the computer readable code further includes instructions for selecting the recipient, by the communication system, in response to the context metadata.

According to an embodiment of the invention, the computer readable code further includes instructions for receiving the conversation initiation request that further includes context metadata that pertains to a user that views the web-page.

According to an embodiment of the invention, the computer readable code further includes instructions for receiving interference indication relating to a closing of the web page viewed in the remote system (by a user or by code), and for renewing the conversation communication session with a communication widget that is included in a popped up window of the remote system.

According to an embodiment of the invention, the computer readable code further includes instructions for evaluating by the communication system a sound quality of voice or video communication with the remote system, and for selecting a processing unit that will participate in a routing of the conversation communication session in response to a result of the evaluating, wherein different processing unit of the communication system have different sound processing capabilities.

According to an embodiment of the invention, the computer readable code further includes instructions for reducing echo, by the communication system, from conversation sound signals that are received from the remote system, before providing the conversation sound signals to the recipient.

According to an embodiment of the invention, the instructions included in the computer readable code for reducing echo, further include instructions for: (a) transmitting to the remote system a first sound sequence; (b) receiving from the remote system a returning sound sequence that is responsive to the first sound sequence; (c) determining an echo reduction parameter in response to a relationship between a first sound sequence parameter and a second sound sequence parameter; and (d) transmitting to the recipient, over a network, a processed sound sequence that was generated in response to the echo reduction parameter from a preprocessed sound sequence which was generated by the remote system.

According to an embodiment of the invention, the computer readable code further includes instructions for determining a delay period between a transmitting time of the first sound sequence and a reception time of the returning sound sequence; for transmitting over the network to the remote system a second sound sequence, after the determining of the delay period; and for processing, by the intermediary communication system, the preprocessed sound sequence in response to the delay period and in response to the second sound sequence, to provide the processed sound sequence.

According to an embodiment of the invention, the computer readable code further includes instructions for determining, by the communication system, an echo reduction parameter and transmitting the echo reduction parameter to the remote system, and for receiving from the remote system a sound sequence that is generated by the remote system in response to the echo reduction parameter.

According to an embodiment of the invention, the computer readable code further includes instructions for receiving the conversation initiation request from the conversation trigger that is included in an advertisement banner in the web page, and for initiating the conversation communication session between the recipient and the communication widget that is incorporated into the advertisement banner.

According to an embodiment of the invention, the computer readable code further includes instructions for receiving from the remote system a user attention indication pertaining to a viewing of the web page by the user; and for receiving a recipient conversation request that is responsive to the user attention indication.

According to an embodiment of the invention, the computer readable code further includes instructions for receiving multiple conversation initiation requests from conversation triggers that are included at least one web page that is viewed in multiple remote systems, and for initiating the conversation communication session between at least two remote systems of the multiple remote systems.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. A communication system, the system comprising:
a first network interface for communicating with a remote system over a network, wherein the first network interface is configured to: (a) receive a conversation initiation request generated in response to an interaction with a conversation trigger that is comprised in a web page that is displayed at a remote system; wherein the conversation initiation request comprises context metadata that pertains to content of the web-page; and (b) provide to the remote system a communication widget that is configured in response to the context metadata; and
a management unit, configured to initiate a communication session between the communication widget and a recipient, for transmitting conversation signals between the remote system and the recipient.

2. The communication system of claim 1, further configured to provide to a content provider that is associated with the web-page information relating to the communication session, wherein the content provider is identified in response to the context metadata.

3. The communication system of claim 1, further comprising a second network interface configured for providing to the recipient conversation related information that is responsive to the context metadata.

4. The communication system of claim 1, wherein the first network interface is configured to provide to the remote system a flash based communication widget.

5. The communication system of claim 1, further comprising a routing module configured for routing conversation packets of the voice communication session, wherein the routing module is further configured for routing transport layer conversation packets.

6. The communication system of claim 1, further comprising a routing module configured for routing conversation packets of the voice communication session, wherein the routing module is further configured for routing application layer conversation packets.

7. The communication system of claim 1, wherein the management unit is further configured to select the recipient in response to the context metadata.

8. The communication system of claim 1, wherein the first network interface is further configured for receiving the conversation initiation request that further comprises context metadata that pertains to a user that views the web-page.

9. The communication system of claim 1, wherein the first network interface is further for receiving interference indication relating to a closing of the web page viewed in the remote system, and wherein the management unit is further configured to renew the voice communication session with a communication widget that is comprised in a popped up window of the remote system.

10. The communication system of claim 1, further comprising a signal evaluation unit configured to evaluate a sound quality of voice communication with the remote system, and wherein the management unit is further configured to select a processing unit that will participate in a routing of the voice communication session in response to a result of the evaluating, wherein different processing unit of the communication system have different sound processing capabilities.

11. The communication system of claim 1, further comprising signal processing module that is configured to reduce echo from conversation sound signals that are received from the remote system, before providing the conversation sound signals to the recipient.

12. The communication system of claim 11, wherein the signal processing module is configured to:
transmit to the remote system a first sound sequence;
receive from the remote system a returning sound sequence that is responsive to the first sound sequence; and
determine an echo reduction parameter in response to a relationship between a first sound sequence parameter and a second sound sequence parameter; and
wherein the communication system is further configured to transmit to the recipient a processed sound sequence that was generated in response to the echo reduction parameter from a preprocessed sound sequence which was generated by the remote system.

13. The communication system of claim 12, wherein the signal processing module is further configured to:
determine a delay period between a transmitting time of the first sound sequence and a reception time of the returning sound sequence;
transmitting, prior to a transmission of the processed sound sequence, to the remote system a second sound sequence, after the determining of the delay period; and
processing the preprocessed sound sequence in response to the delay period and in response to the second sound sequence, to provide the processed sound sequence.

14. The communication system of claim 1, further comprising a signal processing module configured to determine an echo reduction parameter and to transmit the echo reduction parameter to the remote system, wherein the communication system is further configured to receive from the remote system a sound sequence that is generated by the remote system in response to the echo reduction parameter.

15. The communication system of claim 1, wherein the first network interface is further configured to receiving from the remote system a user attention indication pertaining to a viewing of the web page by the user; and to receive a recipient conversation request that is responsive to the user attention indication

16. The communication system of claim 1, wherein the communication system comprises at least one first network interface, wherein the at least one first network interface is for receiving multiple conversation initiation requests from conversation triggers that are comprised in at least one web page that is viewed in multiple remote systems, wherein the management unit is further configured to initiate the voice communication session between at least two remote systems of the multiple remote systems.

17. A method for providing communication, the method comprising carrying out the following steps by a communication system:
receiving a conversation initiation request generated in response to an interaction with a conversation trigger that is comprised in a web page that is displayed at a remote system; wherein the conversation initiation request comprises context metadata that pertains to content of the web-page;
providing to the remote system a communication widget that is configured in response to the context metadata; and
initiating a voice communication session between the communication widget and a recipient, for transmitting conversation signals between the remote system and the recipient.

18. The method of claim 17, further comprising providing to a content provider that is associated with the web-page information relating to the communication session, wherein the content provider is identified in response to the context metadata.

19. The method of claim 17, further comprising providing to the recipient conversation related information that is responsive to the context metadata.

20. The method of claim 17, wherein the providing comprises providing to the remote system a flash based communication widget.

21. The method of claim 17, further comprising routing conversation packets of the voice communication session, wherein the routing comprises routing transport layer conversation packets.

22. The method of claim 17, further comprising routing conversation packets of the voice communication session, wherein the routing comprises routing application layer conversation packets.

23. The method of claim 17, further comprising selecting the recipient, by the communication system, in response to the context metadata.

24. The method of claim 17, wherein the receiving comprises receiving the conversation initiation request that further comprises context metadata that pertains to a user that views the web-page.

25. The method of claim 17, further comprising receiving interference indication relating to a closing of the web page viewed in the remote system, and renewing the voice communication session with a communication widget that is comprised in a popped up window of the remote system.

26. The method of claim 17, further comprising evaluating by the communication system a sound quality of voice communication with the remote system, and selecting a processing unit that will participate in a routing of the voice communication session in response to a result of the evaluating, wherein different processing unit of the communication system have different sound processing capabilities.

27. The method of claim 17, further comprising reducing echo, by the communication system, from conversation sound signals that are received from the remote system, before providing the conversation sound signals to the recipient.

28. The method of claim 27, wherein the reducing echo comprises:
transmitting to the remote system a first sound sequence;
receiving from the remote system a returning sound sequence that is responsive to the first sound sequence;
determining an echo reduction parameter in response to a relationship between a first sound sequence parameter and a second sound sequence parameter; and
transmitting to the recipient, over a network, a processed sound sequence that was generated in response to the echo reduction parameter from a preprocessed sound sequence which was generated by the remote system.

29. The method of claim 28, wherein:
the determining comprises determining a delay period between a transmitting time of the first sound sequence and a reception time of the returning sound sequence;
wherein the transmitting of the processed sound sequence is preceded by transmitting over the network to the remote system a second sound sequence, after the determining of the delay period; and
wherein the method further comprises processing, by the intermediary communication system, the preprocessed sound sequence in response to the delay period and in response to the second sound sequence, to provide the processed sound sequence.

30. The method of claim 17, further comprising determining, by the communication system, an echo reduction parameter and transmitting the echo reduction parameter to the remote system, wherein the method further comprises receiving from the remote system a sound sequence that is generated by the remote system in response to the echo reduction parameter.

31. The method of claim 17, wherein the receiving comprises receiving the conversation initiation request generated in response to an interaction with the conversation trigger that is comprised in an advertisement banner in the web page, and wherein the initiating comprises initiating the voice communication session between the recipient and the communication widget that is incorporated the advertisement banner.

32. The method of claim 17, wherein the receiving of the conversation initiation request comprises receiving from the remote system a user attention indication pertaining to a viewing of the web page by the user; and
wherein the initiating is preceded by receiving a recipient conversation request that is responsive to the user attention indication.

33. The method of claim 17, wherein the receiving comprises receiving multiple conversation initiation requests from conversation triggers that are comprised at least one web page that is viewed in multiple remote systems, wherein the initiating comprises initiating the voice communication session between at least two remote systems of the multiple remote systems.

34. The method of claim 17, wherein the initiating comprises initiating the voice communication session between the communication widget and the recipient which is an advertiser, wherein the communication session is at least partly concurrent to a displaying of an internet advertisement of the advertiser on the remote system. is loaded or upon other noticeable events not necessarily derived from user input.

35. The method of claim 17, wherein the initiating is triggered by clicking by a user of the remote system on a person who appears in an internet video.

36. The method of claim 17, further comprising directing, by a pre-configured server application or via issuing of pre-configured DTMF sequences, voice communication sessions that are initiated in response to conversation initiation requests of different webpages into different queues of an organization's call center.

37. The method of claim 17, further comprising asking from a user to speak and analyzing the gain and spectral pattern of the sequence received at the server, in order to determine if a user's microphone is operational and has a valid volume that would enable a reasonable voice communication session.

38. The method of claim 37, further comprising providing, if a microphone is not present or deemed not present as a result of low overall gain of the entire received signal, PSTN access numbers and access codes that would allow a user to place a PSTN call, wherein the method further comprises routing the PSTN call placed by the user as if it would have been the call the user was trying to trigger by interacting with the conversation trigger.

39. The method of claim 37, further comprising providing, if a microphone is not present or deemed not present as a result of low overall gain of the entire received signal, a chat user interface that allows the user to initiate a textual chat session with a remote operator

40. The method of claim 37, further comprising requesting, if a microphone is not present or deemed not present as a result of low overall gain of the entire received signal, from a user to enter a phone number; wherein the method further comprises calling the phone number via PSTN/VoIP termination services and route that outgoing call to the same route as if it would have been the original call the user is trying to complete by interacting with the conversation trigger.

41. The method of claim 17, further comprising selecting a communications port and protocol for carrying duplex audio signals that form a voice call of the voice communication session, between the communication widget and a server, by opening multiple ports and protocols with short timeout between attempts, and selecting the first port or connection on which a server has responded.

42. The method according to claim 17, further comprising selecting a phone number out of different target phone number, wherein the selecting is responsive to web context that comprises the URL of the web-page, a location within active HTML document and additional metadata of the webpage, wherein the method further comprises routing the voice communication session into a telephony system using the selected phone number.

43. The method of claim 17, wherein the initiating comprises automatically executing at least one pre-configured IVR DTMF/pause script by a server while placing a VoIP client on hold.

44. The method of claim 17, further comprising presenting to a website operator a list of current website visitors to the website, and initiating a voice communication session with the external system in response to an input received from the operator.

45. The method of claim 17, wherein further comprising initiating a chat session with a website visitor who wishes to chat with the recipient, wherein the chat session is handled by a third party widely acceptable chat application or via Chat-To-SMS or Chat-To-Voice.

46. The method of claim 17, further comprising conducting an online chat session between the remote system and another remote system of another user who wishes to engage in chat sessions.

47. The method of claim 17, further comprising controlling a browsing of a browser of the remote system, and navigating the web browser to a pre-configured or ad-hoc URL, using DTMF codes submitted during a voice call.

48. The method of claim 17, further comprising controlling a browsing of a browser of the remote system, and navigating the web browser to a pre-configured or ad-hoc URL, using specialized string token embedded by a mobile recipient of short messages service (SMS) in a chat-to-SMS session.

49. The method of claim 17, further comprising detecting at least one phone number in text of the web-page according to its textual pattern, and automatically translating the at least one phone number into at least one conversation trigger.

50. The method of claim 17, further wherein the initiating is followed by announcing a web context that is associated with the voice communication session using a text to speech module or a playback of a recorded message, wherein the announcing is carried out immediately after the recipient accepts the voice communication session.

51. A computer readable medium, having a computer readable code embodied therein for providing communication, the computer readable code comprising instructions for:
receiving a conversation initiation request generated in response to an interaction with a conversation trigger that is comprised in a web page that is displayed at a remote system;, wherein the conversation initiation request comprises context metadata that pertains to content of the web-page;
providing to the remote system a communication widget that is configured in response to the context metadata; and
initiating a voice communication session between the communication widget and a recipient, for transmitting conversation signals between the remote system and the recipient.
